(19) United States
(12) Patent Application Publication
(10) Pub. No.: US 2026/0051214 A1
(43) Pub. Date: Feb. 19, 2026

(54) SYSTEMS AND METHODS OF ELECTRONIC GAMING INCLUDING A PERSISTENT FEATURE WHILE GAMEPLAY IS ACTIVE AND INACTIVE

(71) Applicant: Aristocrat Technologies, Inc., Las Vegas, NV (US)

(72) Inventors: Erick Ching, Cedar Park, TX (US); Jennifer Mizzi, Ewa Beach, HI (US); Rogelio Decasa, JR., Renton, WA (US); Nathan Warms, Austin, TX (US); Steven Richardson, Round Rock, TX (US); Nicholas Farina, Granger, IN (US); Vinay Jain, Haryana (IN); Jaya Kanojia, New Delhi (IN); Apoorv Agarwal, New Mandi (IN); Kelly Lockheed, Elkridge, MD (US); Scott Hopkins, Austin, TX (US); Zachary Smith, Austin, TX (US); Carlyn Albright, Reno, NV (US); Deanna Hickox, Georgetown, TX (US)

(21) Appl. No.: 18/807,345

(22) Filed: Aug. 16, 2024

(51) Int. Cl. G07F 17/32

(52) U.S. Cl. CPC G07F 17/3213; G07F 17/3237; G07F 17/3267

(57) ABSTRACT

An electronic gaming system including a memory and a processor is described. The processor is configured to cause a persistent feature to be provided as being associated with an electronic game and a player account. The processor is also configured to, as play of the electronic game by the player account progresses, cause a meter associated with the persistent feature to fill, wherein as the meter fills, return to player (RTP) of the electronic game increases, and wherein the meter is caused to be filled based upon a bonus symbol being provided during play of the electronic game. The processor is further configured to, after a predetermined amount of time passes where no plays of the electronic game by the player account occur, cause the meter associated with the persistent feature to empty, wherein as the meter empties, RTP of the electronic game decreases.

### TECHNICAL FIELD

The field of disclosure relates generally to electronic gaming, and more particularly, to systems and methods of electronic gaming including a persistent feature while gameplay is active and inactive.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system is described. The electronic gaming system includes at least one memory with instructions stored thereon and at least one processor in communication with the at least one memory. The instructions, when executed by the at least one processor, cause the at least one processor to cause a persistent feature to be provided as being associated with an electronic game and a player account. The instructions also cause the at least one processor to, as play of the electronic game by the player account progresses, cause a meter associated with the persistent feature to fill wherein as the meter fills, return to player (RTP) of the electronic game increases, and wherein the meter is caused to be filled based at least in part upon at least one bonus symbol being provided during play of the electronic game. The instructions further cause the at least one processor to, after a predetermined amount of time passes where no plays of the electronic game by the player account occur, cause the meter associated with the persistent feature to empty wherein as the meter empties, RTP of the electronic game decreases.

In another aspect, at least one non-transitory computer-readable storage medium with instructions stored thereon is described. The instructions, in response to execution by at least one processor, cause the at least one processor to cause a persistent feature to be provided as being associated with an electronic game and a player account. The instructions also cause the at least one processor to, as play of the electronic game by the player account progresses, cause a meter associated with the persistent feature to fill wherein as the meter fills, return to player (RTP) of the electronic game increases, and wherein the meter is caused to be filled based at least in part upon at least one bonus symbol being provided during play of the electronic game. The instructions further cause the at least one processor to, after a predetermined amount of time passes where no plays of the electronic game by the player account occur, cause the meter associated with the persistent feature to empty, wherein as the meter empties, RTP of the electronic game decreases.

In another aspect, a method of electronic gaming implemented by at least one processor in communication with at least one memory is described. The method includes causing a persistent feature to be provided as being associated with an electronic game and a player account. The method also includes, as play of the electronic game by the player account progresses, causing a meter associated with the persistent feature to fill wherein as the meter fills, return to player (RTP) of the electronic game increases, and wherein the meter is caused to be filled based at least in part upon at least one bonus symbol being provided during play of the electronic game. The method further includes, after a predetermined amount of time passes where no plays of the electronic game by the player account occur, causing the meter associated with the persistent feature to empty, wherein as the meter empties, RTP of the electronic game decreases.

### BRIEF DESCRIPTION OF THE DRAWINGS

FIG. 1 is an exemplary diagram showing several EGMs networked with various gaming related servers.

FIG. 2A is a block diagram of an example EGM that includes exemplary internal electronic components, and connections to exemplary gaming systems in accordance with the present disclosure.

FIG. 2B depicts an example casino gaming environment in accordance with the present disclosure.

FIG. 2C is a diagram that shows examples of components of a system for providing online gaming in accordance with the present disclosure.

FIG. 3 illustrates, in block diagram form, an embodiment of a game processing architecture algorithm that implements a game processing pipeline for the play of a game in accordance with various embodiments described herein.

FIG. 4 illustrates an example screenshot and/or interface of an electronic game including a persistent feature while gameplay is active and inactive, in accordance with the present disclosure.

FIG. 5 illustrates another example screenshot and/or interface of an electronic game including a persistent feature while gameplay is active and inactive, in accordance with the present disclosure.

FIG. 6 illustrates another example screenshot and/or interface of an electronic game including a persistent feature while gameplay is active and inactive, in accordance with the present disclosure.

FIG. 7 illustrates another example screenshot and/or interface of an electronic game including a persistent feature while gameplay is active and inactive, in accordance with the present disclosure.

FIG. 8 illustrates another example screenshot and/or interface of an electronic game including a persistent feature while gameplay is active and inactive, in accordance with the present disclosure.

FIG. 9 illustrates another example screenshot and/or interface of an electronic game and/or transition thereof including a persistent feature while gameplay is active and inactive, in accordance with the present disclosure.

FIG. 10 illustrates another example screenshot and/or interface of an electronic game and/or transition thereof including a persistent feature while gameplay is active and inactive, in accordance with the present disclosure.

FIG. 11 illustrates another example screenshot and/or interface of an electronic game including a persistent feature while gameplay is active and inactive, in accordance with the present disclosure.

FIG. 12 illustrates another example screenshot and/or interface of an electronic game and/or transition thereof including a persistent feature while gameplay is active and inactive, in accordance with the present disclosure.

FIG. 13 illustrates another example screenshot and/or interface of an electronic game and/or transition thereof including a persistent feature while gameplay is active and inactive, in accordance with the present disclosure.

FIG. 14 illustrates another example screenshot and/or interface of an electronic game and/or transition thereof including a persistent feature while gameplay is active and inactive, in accordance with the present disclosure.

FIG. 15 illustrates another example screenshot and/or interface of an electronic game including a persistent feature while gameplay is active and inactive, in accordance with the present disclosure.

FIG. 16 illustrates another example screenshot and/or interface of an electronic game and/or transition thereof including a persistent feature while gameplay is active and inactive, in accordance with the present disclosure.

FIG. 17 illustrates another example screenshot and/or interface of an electronic game and/or transition thereof including a persistent feature while gameplay is active and inactive, in accordance with the present disclosure.

FIG. 18 illustrates another example screenshot and/or interface of an electronic game including a persistent feature while gameplay is active and inactive, in accordance with the present disclosure.

FIG. 19 illustrates another example screenshot and/or interface of an electronic game and/or transition thereof including a persistent feature while gameplay is active and inactive, in accordance with the present disclosure.

FIG. 20 illustrates another example screenshot and/or interface of an electronic game and/or transition thereof including a persistent feature while gameplay is active and inactive, in accordance with the present disclosure.

FIG. 21 illustrates another example screenshot and/or interface of an electronic game and/or transition thereof including a persistent feature while gameplay is active and inactive, in accordance with the present disclosure.

FIG. 22 illustrates another example screenshot and/or interface of an electronic game and/or transition thereof including a persistent feature while gameplay is active and inactive, in accordance with the present disclosure.

FIG. 23 illustrates another example screenshot and/or interface of an electronic game and/or transition thereof including a persistent feature while gameplay is active and inactive, in accordance with the present disclosure.

FIG. 24 illustrates another example screenshot and/or interface of an electronic game and/or transition thereof including a persistent feature while gameplay is active and inactive, in accordance with the present disclosure.

FIG. 25 illustrates another example screenshot and/or interface of an electronic game and/or transition thereof including a persistent feature while gameplay is active and inactive, in accordance with the present disclosure.

FIG. 26 illustrates another example screenshot and/or interface of an electronic game including a persistent feature while gameplay is active and inactive, in accordance with the present disclosure.

FIG. 27 illustrates another example screenshot and/or interface of an electronic game including a persistent feature while gameplay is active and inactive, in accordance with the present disclosure.

FIG. 28 illustrates another example screenshot and/or interface of an electronic game including a persistent feature while gameplay is active and inactive, in accordance with the present disclosure.

FIG. 29 illustrates an example method of electronic gaming including a persistent feature while gameplay is active and inactive, in accordance with the present disclosure.

### DETAILED DESCRIPTION

Provided herein are systems and methods for electronic gaming including a persistent feature (e.g., a pet) while gameplay is active (e.g., actively being played) and inactive (e.g., not actively being played), in accordance with the present disclosure. For example, an electronic game may be provided where a player “adopts” a virtual pet that sits above reels. A pet happiness meter may include hearts. When a trigger condition is satisfied (e.g., scatter symbols being provided on the reels), a pet happiness meter may increase (e.g., +1 heart) and a random feature may be unlocked. The random feature may be play of an electronic game where no wager is provided (e.g., a free play and/or play where a secondary currency is utilized to “purchase” a play of the electronic game).

A status (e.g., amount filled) of the pet happiness meter may be preserved if the player plays the electronic game at a predefined frequency (e.g., at least once per day). If the player does not play the electronic game at the predefined frequency, the pet happiness meter may go down and unlocked features associated therewith may return to a locked state. As the happiness meter fills, a higher frequency of randomly unlocked features may be provided in play of the electronic game.

As explained above, play on EGMs typically involves a player establishing a credit balance by inputting money, or another form of monetary credit, and placing a monetary wager (from the credit balance) on one or more outcomes of an instance (or single play) of a primary or base game. Games are designed to return a certain percentage of the amount wagered back to the player over the course of many plays or instances of the game, which is generally referred to as return to player (RTP). However, certain technical challenges arise when an electronic game is initiated and no amount wagered is provided.

For instance, in some known electronic games, RTP is controlled based at least upon an amount wagered. Certain pay tables and/or lookup tables may be utilized to determine RTP based on an amount wagered. However, as explained in further detail herein, the present disclosure includes embodiments where an electronic game (e.g., bonus play of the electronic game or a play of a bonus game) may be triggered without an amount wagered being provided. For example, a play of the electronic game may be triggered based on an input of secondary currency to purchase the play (e.g., rather than inputting a dollar amount, secondary currency that has been accumulated in a player account and/or digital wallet may be utilized to “purchase” the play). Notably, RTP still needs to be determined for the electronic game even though no amount wagered is provided.

Accordingly, various technical solutions are provided herein to address the technical problems that arise when an electronic game is initiated but no amount wagered is provided. For instance, improved computer (e.g., electronic gaming device) capabilities are provided herein in order to achieve a designated/target RTP when no amount is wagered.

As some example technical solutions to achieve a target RTP when no amount is wagered: i) an average wager amount across a plurality of plays associated with a player account may be determined and an RTP associated with the average wager amount may be utilized for a play where no amount wagered is provided; ii) an average wager amount across a plurality of plays associated with a player account where secondary currency is provided may be determined and an RTP associated with the average wager amount may be utilized for a play where no amount wagered is provided; and/or iii) wager amounts of plays where secondary currency is provided to a player account may be stored as being associated with the secondary currency such that when the secondary currency is spent, an RTP associated with a wager amount when the secondary currency was provided is utilized (e.g., “first in, first out”).

Further technical benefits include (i) displaying large quantities of complex information in a relatively small display area; (ii) communicating complex information with easy-to-understand animations on a display; (iii) clearly indicating when a player has entered a bonus game (e.g., a free spin game); (iv) efficiently communicating different game rules for the bonus game on the display during game play; and (v) providing versatility as to which devices (e.g., EGMs, mobile devices, etc.) the games described herein may be played on because of the efficient display area designs described herein.

For instance, various interface improvements are provided herein to efficiently and effectively communicate information. As an example, a persistent feature is provided herein (e.g., a pet above the reels) that becomes more animated as RTP increases. The persistent feature may also become less animated when RTP decreases. Further, various display features and/or animations are provided (e.g., heart meter, XP meter, etc.) to communicate a status of the persistent feature as well as which features (e.g., game enhancements, shop features, etc.) are locked or unlocked.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game and navigate to the next play of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Further, different specific lookups may be utilized during play of the example base game described herein in order to properly provide accumulation of progress in a heart meter (e.g., pet happiness meter) and random application of game enhancements associated therewith while controlling RTP. For instance, different reel sets may be selected depending on how full the heart meter is to control the likelihood with which hearts are obtained (e.g., as the heart meter fills, reel sets with less heart symbols may be selected such that later positions of the heart meter are more difficult to fill than earlier positions on the heart meter) and/or to control RTP at various heart levels.

As an example, different reel sets may be stored in memory (e.g., in a lookup table) as being associated with different statuses (e.g., toward completion) of the heart meter. Pluralities of reel sets may be associated with each heart meter status (e.g., how many hearts are “filled”). One of the plurality of reel sets corresponding to a current status of heart meter may be randomly selected for use in a play of the game. In some embodiments, heart symbols can still land after the heart meter is completely filled, and will cause one free spin to be provided. In some embodiments, during the free spin, one of the three features (e.g., as explained herein) may be randomly selected and provided. In some embodiments, more or less features and/or positions of the heart meter (e.g., than the three shown) are envisioned.

In the example embodiment, an electronic gaming system is described. The electronic gaming system includes at least one memory with instructions stored thereon and at least one processor in communication with the at least one memory. The instructions, when executed by the at least one processor, cause the at least one processor to cause a persistent feature to be provided as being associated with an electronic game and a player account. The instructions also cause the at least one processor to, as play of the electronic game by the player account progresses, cause a meter associated with the persistent feature to fill wherein as the meter fills, return to player (RTP) of the electronic game increases, and wherein the meter is caused to be filled based at least in part upon at least one bonus symbol being provided during play of the electronic game. The instructions further cause the at least one processor to, after a predetermined amount of time passes where no plays of the electronic game by the player account occur, cause the meter associated with the persistent feature to empty wherein as the meter empties, RTP of the electronic game decreases.

In some embodiments, the instructions further cause the at least one processor to randomly cause collectibles (e.g., secondary currency) to be provided during play of the electronic game. In some embodiments, the instructions further cause the at least one processor to randomly cause the collectibles to be provided as an overlay at one or more symbol positions of a plurality of symbol positions for the electronic game. In some embodiments, the instructions further cause the at least one processor to cause the collectibles to be stored in the player account.

In some embodiments, the instructions further cause the at least one processor to cause the collectibles to be stored in the player account (e.g., digital wallet) as being associated with input amounts at which the electronic game was being played at when the collectibles were provided. In some embodiments, the instructions further cause the at least one processor to cause a cosmetic enhancement to be applied to the persistent feature based upon an input of an amount of collectibles from the player account.

In some embodiments, the instructions further cause the at least one processor to cause a bonus play of the electronic game to be provided based upon receipt an input of an amount of collectibles from the player account. In some embodiments, the instructions further cause the at least one processor to determine an RTP for the bonus play based at least in part upon one or more input amounts of the input amounts at which the electronic game was being played at when the collectibles were provided.

In some embodiments, the instructions further cause the at least one processor to, in a virtual game lobby comprising a plurality of selectors associated with a plurality of electronic games, cause a status of the meter to be displayed on the selector of the plurality of selectors associated with the electronic game.

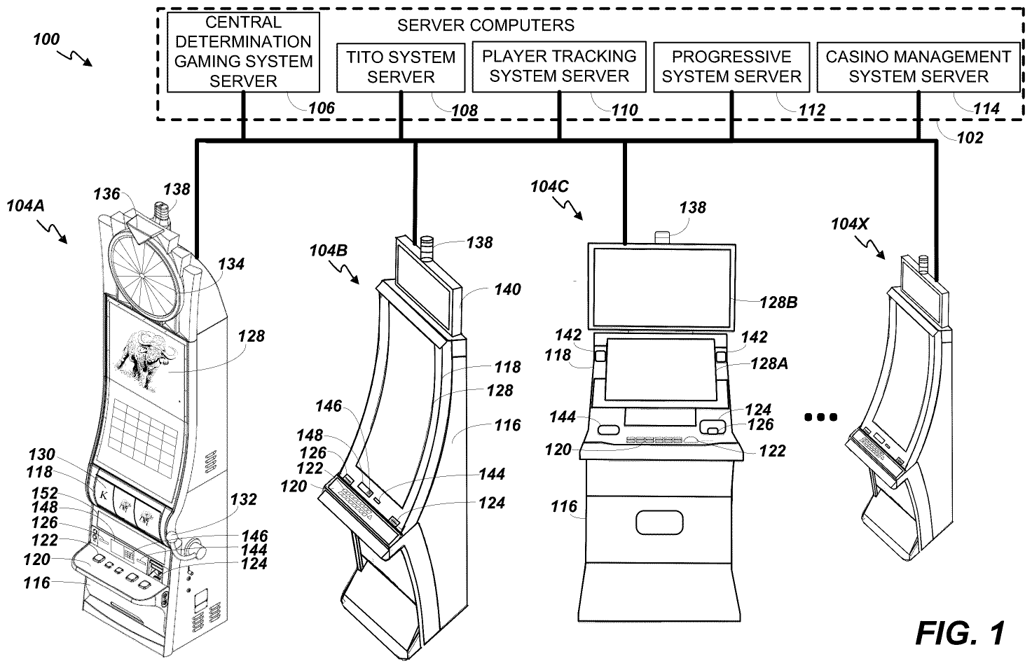

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some embodiments, a player tracking card reader 144, a transceiver for wireless communication with a mobile device (e.g., a player's smartphone), a keypad 146, and/or an illuminated display 148 for reading, receiving, entering, and/or displaying player tracking information is provided in EGM 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), paylines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

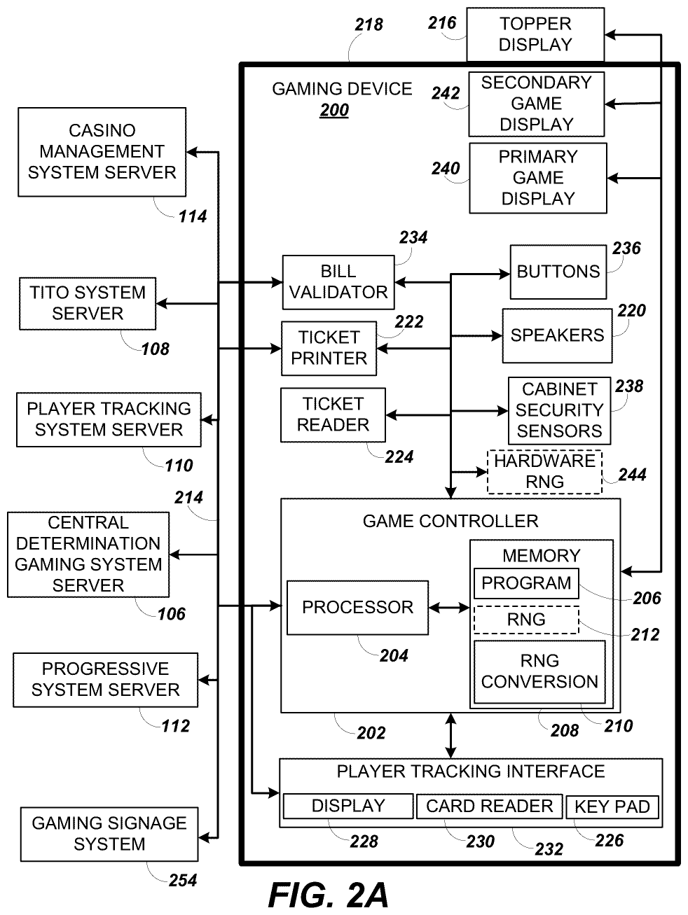

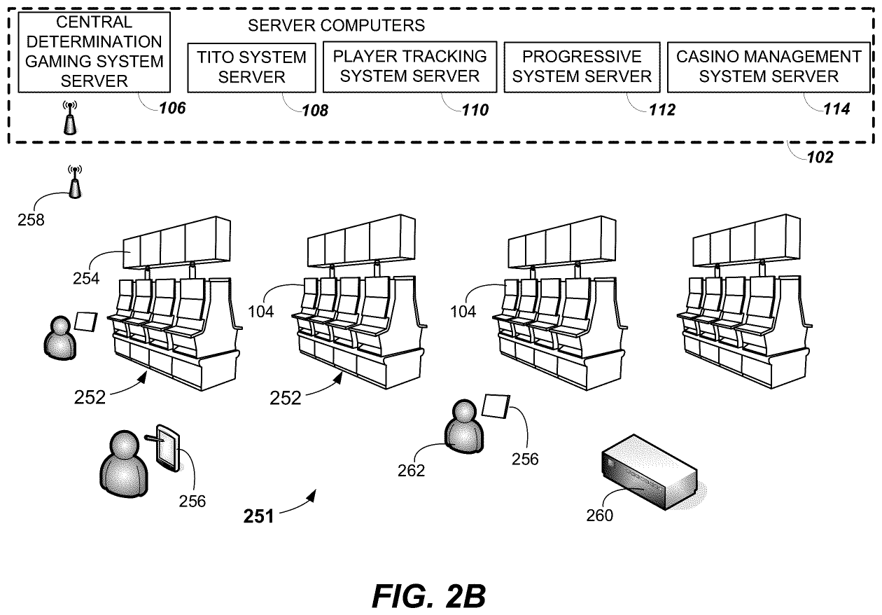

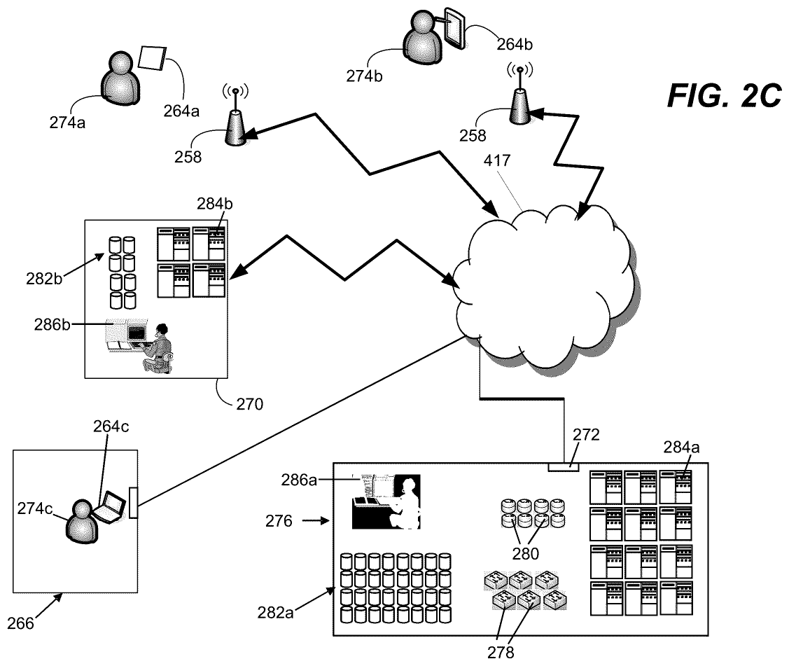

Many or all the above described components can be controlled by circuitry (e.g., a game controller) housed inside the main cabinet 116 of the gaming device 104A, the details of which are shown in FIG. 2.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape display 128A may have a curvature radius from top to bottom, or alternatively from side to side. In some embodiments, display 128A is a flat panel display. Main display 128A is typically used for primary game play while secondary display 128B is typically used for bonus game play, to show game features or attraction activities while the game is not in play or any other information or media desired by the game designer or operator. In some embodiments, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems in accordance with the present disclosure. All or parts of the example gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), and a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that does not retain data values upon loss of power. Nonvolatile memory is memory that does retain data upon a loss of power. Examples of memory 208 include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various embodiments (e.g., game mechanics) described herein. Stated another way, game program 206 represents an executable program stored in any portion or component of memory 208. In one or more embodiments, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be setup to generate one or more game instances based on instructions and/or data that gaming device 200 exchange with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208. Note that embodiments of the present disclosure represent an improvement in the art of EGM software and provide new technology in that they provide for a secondary currency, different from a traditional primary currency, which can be awarded to players and spent by players to further enhance the player experience in a gaming environment (e.g., a casino gaming environment, a virtual/mobile gaming environment, etc.), and, in some embodiments, more than one gaming environment (e.g., the same secondary currency may be spent in a casino and in a virtual/mobile gaming environment). These embodiments are thus not merely new game rules or simply a new display pattern.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 includes an RNG 212 that utilizes hardware and/or software to generate RNG outcomes that lack any pattern. The RNG operations are often specialized and non-generic in order to comply with regulatory and gaming requirements. For example, in a reel game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more embodiments, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can setup the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

In the example embodiment, multiple RNGs 212 are provided in addition to multiple lookup/pay tables in order to implement the secondary currency. Further, additional data storage is utilized such that secondary currency is stored in a way that allows the secondary currency to be spent in land-based casinos, as well as in virtual environments and so that electronic games wherein secondary currency may be spent and/or earned are tracked automatically. Additionally, display device performance is improved to communicate information regarding secondary currency to players (e.g., how to earn secondary currency, how much secondary currency has been earned, etc.).

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gamine device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Although FIGS. 1 and 2A illustrate specific embodiments of a gaming device (e.g., gaming devices 104A-104X and 200), the disclosure is not limited to those embodiments shown in FIGS. 1 and 2A. For example, not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Additionally, or alternatively, gaming devices 104A-104X and 200 can include credit transceivers that wirelessly communicate (e.g., Bluetooth or other near-field communication technology) with one or more mobile devices to perform credit transactions. As an example, bill validator 234 could contain or be coupled to the credit transceiver that output credits from and/or load credits onto the gaming device 104A by communicating with a player's smartphone (e.g., a digital wallet interface). Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2A are examples to facilitate ease of description and explanation.

FIG. 2B depicts an example casino gaming environment in accordance with the present disclosure. In this example, the casino 251 includes banks 252 of EGMs 104. In this example, each bank 252 of EGMs 104 includes a corresponding gaming signage system 254. According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming in accordance with the present disclosure. As with other figures presented in this disclosure, the numbers, types and arrangements of gaming devices shown in FIG. 2C are merely shown by way of example. In this example, various gaming devices, including, but not limited to, end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations, one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

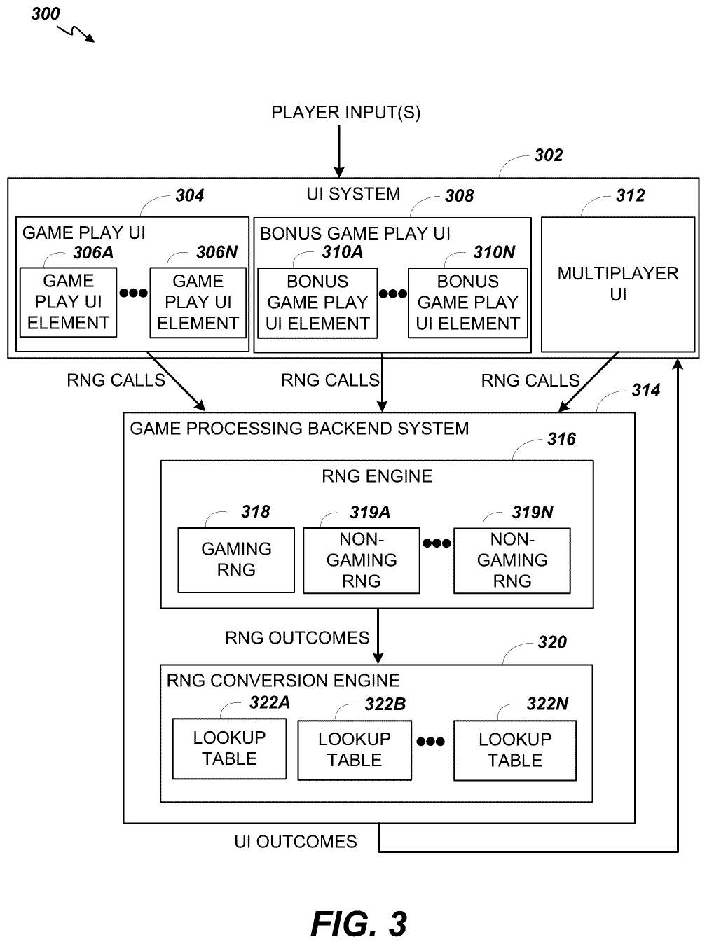

FIG. 3 illustrates, in block diagram form, an embodiment of a game processing architecture 300 that implements a game processing pipeline for the play of a game in accordance with various embodiments described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more embodiments, at least some of the game play UI element 306A-306N are similar to the bonus game play UI elements 310A-310N. In other embodiments, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 corresponds to RNG 212 shown in FIG. 2. As previously discussed with reference to FIG. 2, gaming RNG 318 often performs specialized and non-generic operations that comply with regulatory and/or game requirements. For example, because of regulation requirements, gaming RNG 318 could be a cryptographic random or pseudorandom number generator (PRNG) (e.g., Fortuna PRNG) that securely produces random numbers for one or more game features. To generate random numbers, gaming RNG 318 could collect random data from various sources of entropy, such as from an operating system (OS). Alternatively, non-gaming RNGs 319A-319N may not be cryptographically secure and/or be computationally less expensive. Non-gaming RNGS 319A-319N can, thus, be used to generate outcomes for non-gaming purposes. As an example, non-gaming RNGs 319A-319N can generate random numbers for such as generating random messages that appear on the gaming device.

The RNG conversion engine 320 processes each RNG outcome from RNG engine 316 and converts the RNG outcome to a UI outcome that is feedback to the UI system 302. With reference to FIG. 2, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

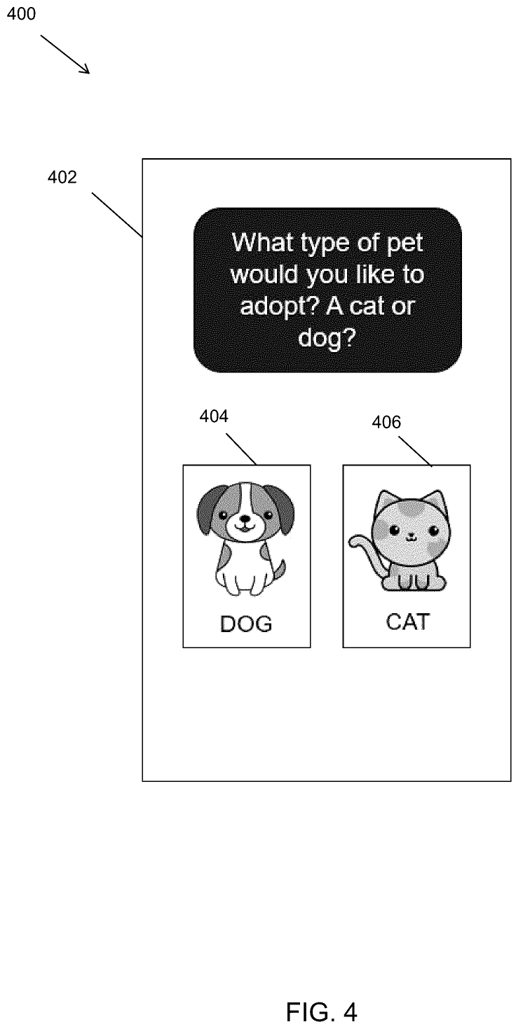

FIG. 4 illustrates an example screenshot and/or interface 400 of an electronic game including a persistent feature while gameplay is active and inactive, in accordance with the present disclosure. As shown in FIG. 4, the first time a player account (e.g., associated with a player) loads into an example game described herein, a virtual adoption agency 402 is displayed. The player is presented with the option to adopt either a dog 404 or a cat 406, as indicated by message 408. In some embodiments, other types of available pets and/or persistent features are also envisioned.

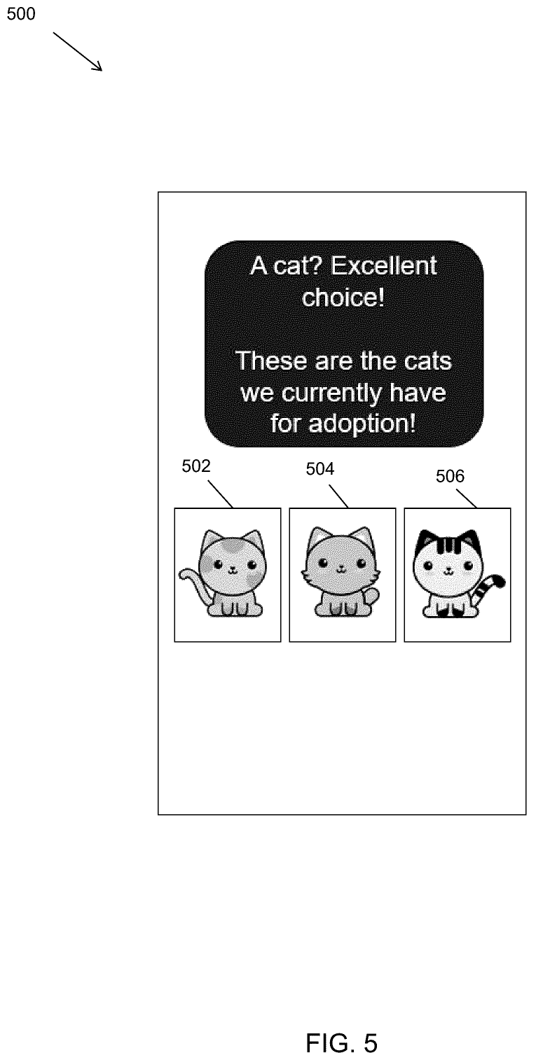

FIG. 5 illustrates another example screenshot and/or interface 500 of an electronic game including a persistent feature while gameplay is active and inactive, in accordance with the present disclosure. As shown in FIG. 5, the player has selected to adopt a cat (e.g., at screenshot and/or interface 400). Now that the player has selected the type of animal they would like to adopt, a plurality of pets 502, 504, 506 are displayed that they can select from (e.g., differing in color and/or pattern). The type of pet the player selected is stored in memory as being associated with the player account (e.g., as described herein, memory may be at a local device, at a remote server, etc.).

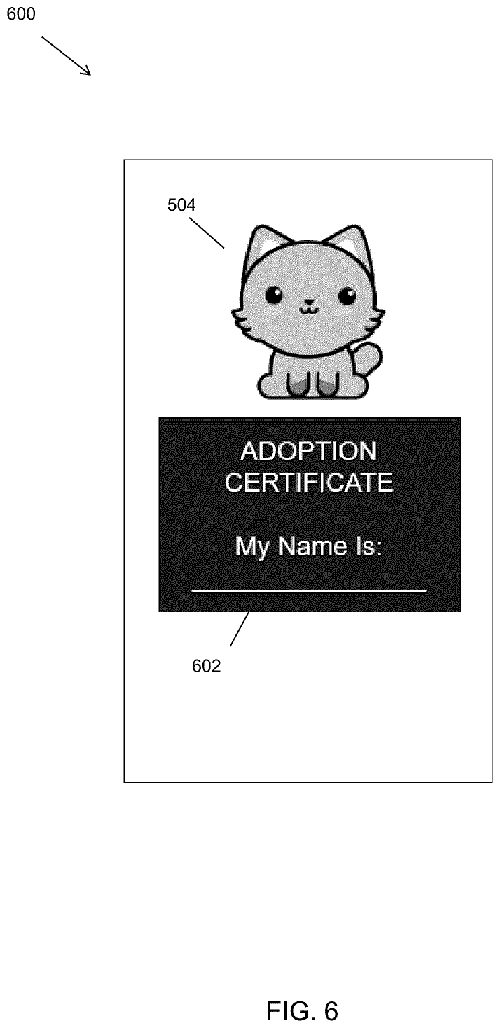

FIG. 6 illustrates another example screenshot and/or interface 600 of an electronic game including a persistent feature while gameplay is active and inactive, in accordance with the present disclosure. As shown in FIG. 6, the player has selected to adopt one of the plurality of pets 502-506 shown at screenshot and/or interface 600 (e.g., pet 504). The selection of pet 504 is stored in memory as being associated with the player account. Now that the player has selected pet 504, they are presented with an adoption certificate 602 to complete (e.g., to name their pet). Once entered, the name of the pet is stored in memory as being associated with the player account. When the adoption process is finished, an electronic game (e.g., a reel-style slot game) associated with the selected pet is displayed. Additional and/or alternative steps in the adoption process are also envisioned (e.g., further customization of the pet).

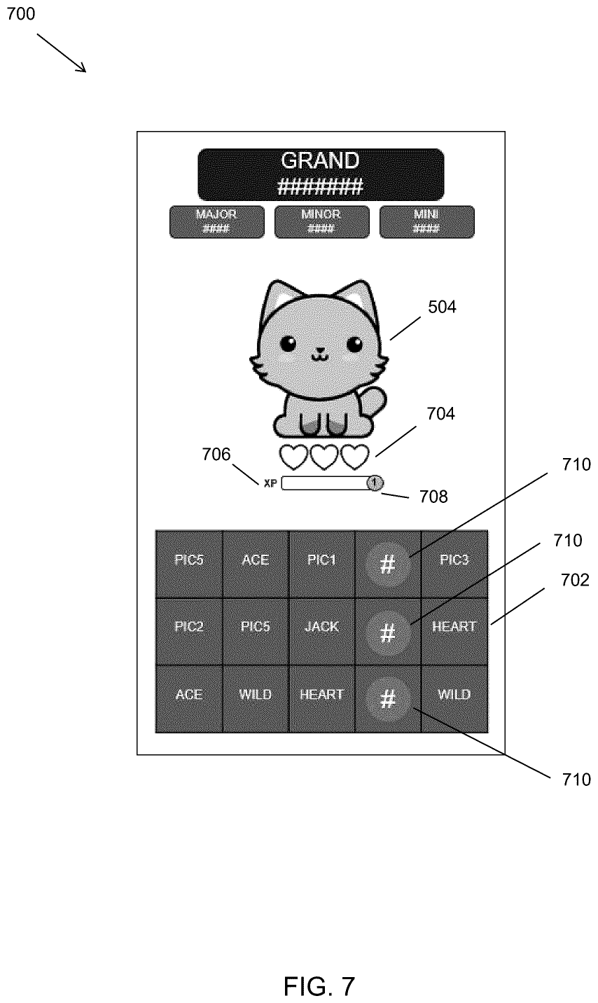

FIG. 7 illustrates another example screenshot and/or interface 700 of an electronic game including a persistent feature while gameplay is active and inactive, in accordance with the present disclosure. In the example embodiment, the base game includes a 3×5 matrix including reels 702 (e.g., a 30-line game). Pet 504, as selected during the adoption process, is displayed above reels 702. A heart meter 704 displays the pet's current happiness level. An XP (e.g., experience) meter 706 displays the pet's current XP progress (e.g., toward a next level). A badge 708 displays the pet's current level. Heart meter 704 and XP meter 706 may be associated with different features of the electronic game (e.g., RTP of the electronic game, enhancements available for purchase, etc.) as explained in further detail herein.

Cash on reel (COR) symbols 710 may be provided on reels 702 during the base game (e.g., symbols that are associated with and display credit values, Mini, Minor, and/or Major jackpots). Heart symbols may appear on the reels (e.g., reels 1, 3, & 5, as numbered from left to right). The heart symbols may affect heart meter 704 (e.g., cause heart meter 704 to fill), as explained in further detail herein.

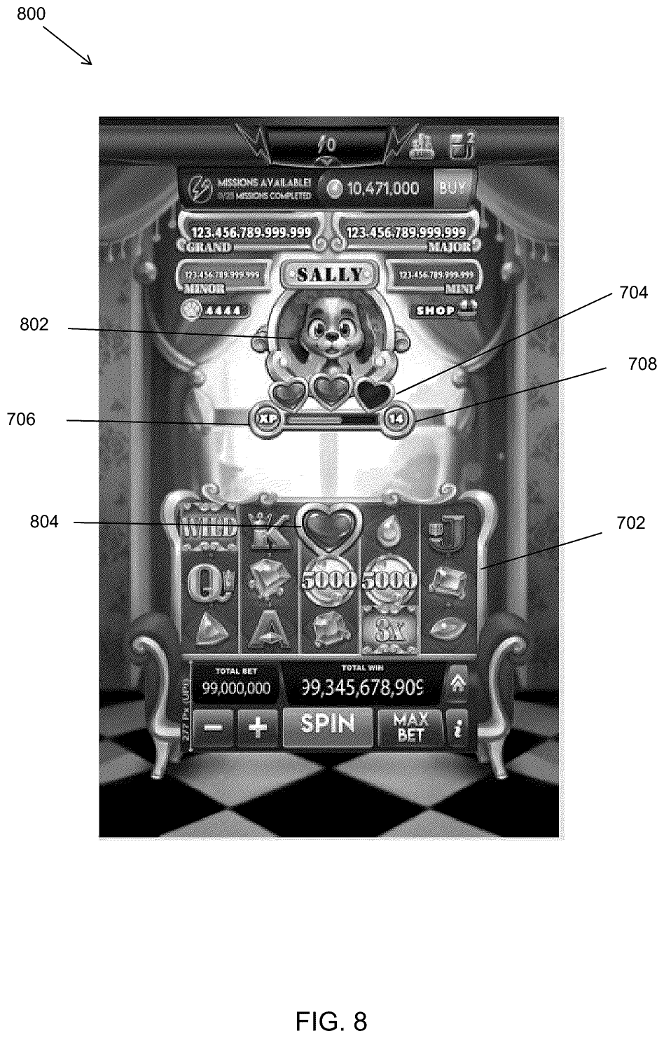

FIG. 8 illustrates another example screenshot and/or interface 800 of the electronic game shown in FIG. 7. In the example shown in FIG. 8, heart meter 704, XP meter 706, and badge 708 remain displayed. Another example of a pet 802 is also displayed. Further, an example of a heart symbol 804 is displayed on reels 702.

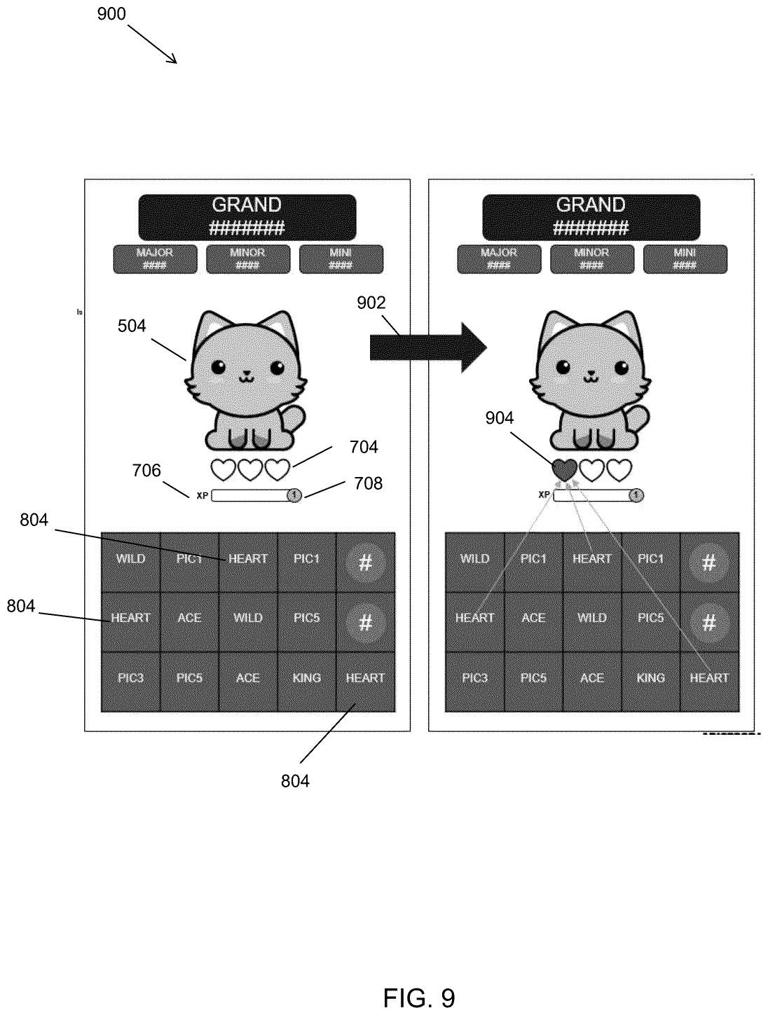

FIG. 9 illustrates another example screenshot and/or interface 900 of an electronic game and/or transition thereof including a persistent feature while gameplay is active and inactive, in accordance with the present disclosure. Whenever heart symbols 804 land on reels 702, heart meter 704 (e.g., a pet happiness meter) may be filled by one heart. For instance, FIG. 9 illustrates one or more heart symbols 804 being provided on reels 702 in a game outcome, followed by a transition 902 to heart meter 704 being filled by a heart 904. Further, when heart symbols 804 land on reels 702, an animation of feeding or playing with pet 504 may be displayed (e.g., to communicate that the pet is being taken care of).

A free spin may be provided when heart symbol 804 lands on reels 702. For the free spin, different features may be provided depending on the number of hearts currently filled in heart meter 704 (e.g., heart meter position #1 (e.g., leftmost)—add wilds, heart meter position #2 (e.g., center)—Blast CORs (e.g., automatically provide values associated with displayed COR symbols), heart meter position #3 (e.g., rightmost)—grow/expand reels). The corresponding pet feature (e.g., associated with whichever heart is filled) is then “unlocked” to be awarded randomly during any play of the base game. As the heart meter is filled, the likelihood of randomly triggering one of the pet's features during a play increases (e.g., thereby increasing RTP of the game).

As heart meter 704 fills, pet 504 may also become more “active” (e.g., presented/displayed in different states of excitement, corresponding to how full heart meter 704 is, akin to a metamorphic to indicate the increased likelihood of random features occurring).

Different reel sets may be selected depending on how full heart meter 704 is to control the likelihood with which hearts are obtained (e.g., as heart meter 704 fills, reel sets with less heart symbols 804 may be selected such that later positions of heart meter 704 are more difficult to fill than earlier positions of heart meter 704) and/or to control RTP at various heart levels. For instance, different reel sets may be stored in memory (e.g., in a lookup table) as being associated with different statuses (e.g., toward completion) of heart meter 704. Pluralities of reel sets may be associated with each heart meter status. One of the plurality of reel sets corresponding to a current status of heart meter 704 may be randomly selected. In some embodiments, heart symbols 804 can still land after heart meter 704 is completely filled, and will cause one free spin to be provided. In some embodiments, during the free spin, one of the three features (e.g., as explained herein) may be randomly selected and provided. In some embodiments, more or less features and/or positions of heart meter 704 (e.g., than the three shown) are envisioned.

For free plays/spins described herein (e.g., randomly provided and/or purchased in the shop), various technical solutions are provided to address the technical problems that arise when an electronic game is initiated but no amount wagered is provided. For instance, improved computer (e.g., electronic gaming device) capabilities are provided herein in order to achieve a designated/target RTP when no amount is wagered.

As some example technical solutions to achieve a target RTP when no amount is wagered: i) an average wager amount across a plurality of plays associated with a player account may be determined and an RTP associated with the average wager amount may be utilized for a play where no amount wagered is provided; ii) an average wager amount across a plurality of plays associated with a player account where secondary currency is provided may be determined and an RTP associated with the average wager amount may be utilized for a play where no amount wagered is provided; and/or iii) wager amounts of plays where secondary currency is provided to a player account may be stored as being associated with the secondary currency such that when the secondary currency is spent, an RTP associated with a wager amount when the secondary currency was provided is utilized (e.g., “first in, first out”).

Further, wager amounts at which the secondary currency is earned may be stored at a server, instead of being stored locally at an electronic gaming device. For instance, known EGMs may accept a cash amount, store a cash balance, and provide a ticket upon a player cash out. However, in the example embodiment described herein, secondary currency balances may be managed remotely (e.g., at a server) instead of locally at an EGM.

In other words, player secondary currency balances may be persistently stored on a server as being associated with a player ID (e.g., associated with a player account and/or digital wallet). Also stored as being associated with the player ID is wager information associated with the player ID that may be utilized when secondary currency is redeemed.

As an example, a player may log in to play an electronic game at an electronic gaming device (e.g., EUDs 264a-c) and the electronic gaming device may send a message (e.g., including a player ID) to a server indicating that the player has logged in. The server may then look up a secondary currency balance associated with the player ID and transmit a response message to the electronic gaming device that indicates the secondary currency balance associated with the player ID. As the player accumulates more secondary currency by playing at the electronic gaming device, the electronic gaming device may update the server with updated secondary currency balances associated with the player ID (e.g., after each play, after a set amount of time, at player log out, etc.).

The electronic gaming device may also notify the server when the player has requested to redeem secondary currency. For example, a player may redeem secondary currency for one or more free plays of an electronic game at the electronic gaming device. The electronic gaming device may transmit a message to the server to remove the amount of secondary currency spent on the one or more free plays from the secondary currency balance associated with the player ID.

Further, an electronic gaming device will need to know at which RTP to provide the one or more free plays. Accordingly, the server may transmit wager information associated with the player ID to the electronic gaming device that corresponds to the RTP to be used to provide the one or more free plays. For instance, to determine the RTP to be used to provide the one or more free plays, the electronic gaming device may utilize i) an average wager amount across a plurality of plays associated with a player account may be determined and an RTP associated with the average wager amount may be utilized for a play where no amount wagered is provided, ii) an average wager amount across a plurality of plays associated with a player account where secondary currency is provided may be determined and an RTP associated with the average wager amount may be utilized for a play where no amount wagered is provided, or iii) wager amounts of plays where secondary currency is provided to a player account may be stored as being associated with the secondary currency such that when the secondary currency is spent, an RTP associated with a wager amount when the secondary currency was provided is utilized (e.g., “first in, first out”). Thus, the one or more free plays are provided with an RTP based upon player wager information, despite no wager being provided for the one or more free plays.

Further, various security benefits are provided by secondary currency balances being stored and updated remotely (e.g., at a server) instead of locally at a gaming device. For example, secondary currency, as described herein, may be utilized at a number of different electronic gaming devices (e.g., land-based, mobile, etc.). Accordingly, technical challenges would arise in attempting to manage secondary currencies at these different gaming devices (e.g., that are managed and/or controlled by different entities). Thus, to ensure safe handling of the secondary currency, the secondary currency is stored and updated remotely to prevent hacking that may occur at local gaming devices.

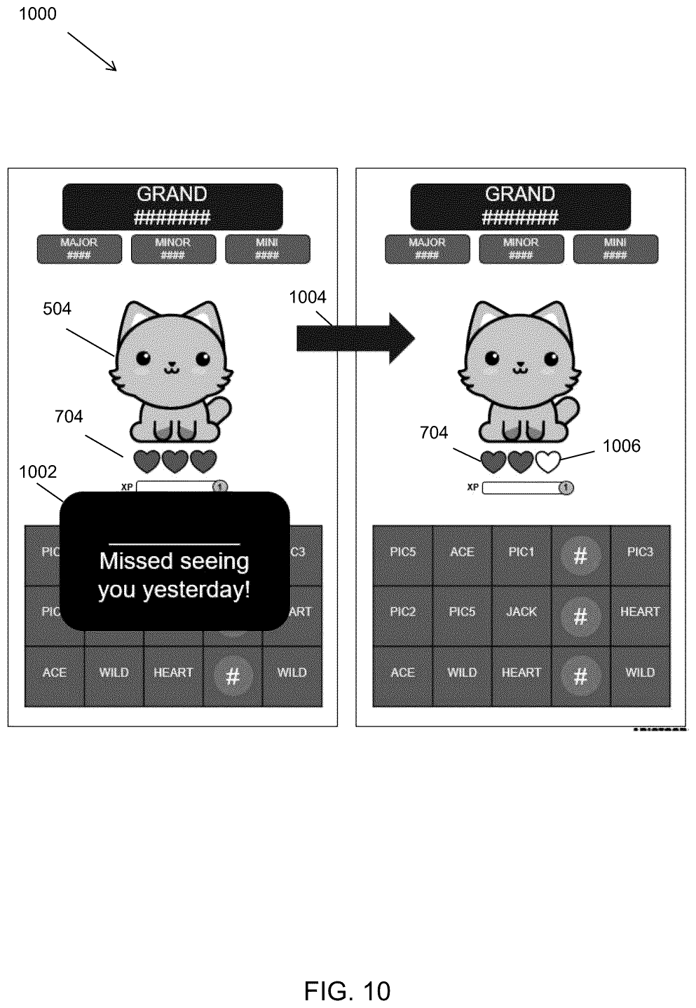

FIG. 10 illustrates another example screenshot and/or interface 1000 of an electronic game and/or transition thereof including a persistent feature while gameplay is active and inactive, in accordance with the present disclosure. Each day (e.g., and/or another predetermined time) a player account does not log in and/or visit pet 504 by playing the game, heart meter 704 may be decreased by one heart (e.g., or another amount). When pet 504 decreases in happiness (e.g., based on heart meter 704), the frequency with which random features are provided is lowered (e.g., thereby lowering RTP of the game) and the corresponding removed heart's special feature is no longer available to be provided (e.g., until the heart meter 704 fills to include the removed heart). For instance, FIG. 10 illustrates a message 1002 communicating that a heart will be removed because the player account did not log in on a previous day, along with a transition 1004 to a heart 1006 being removed from heart meter 704.

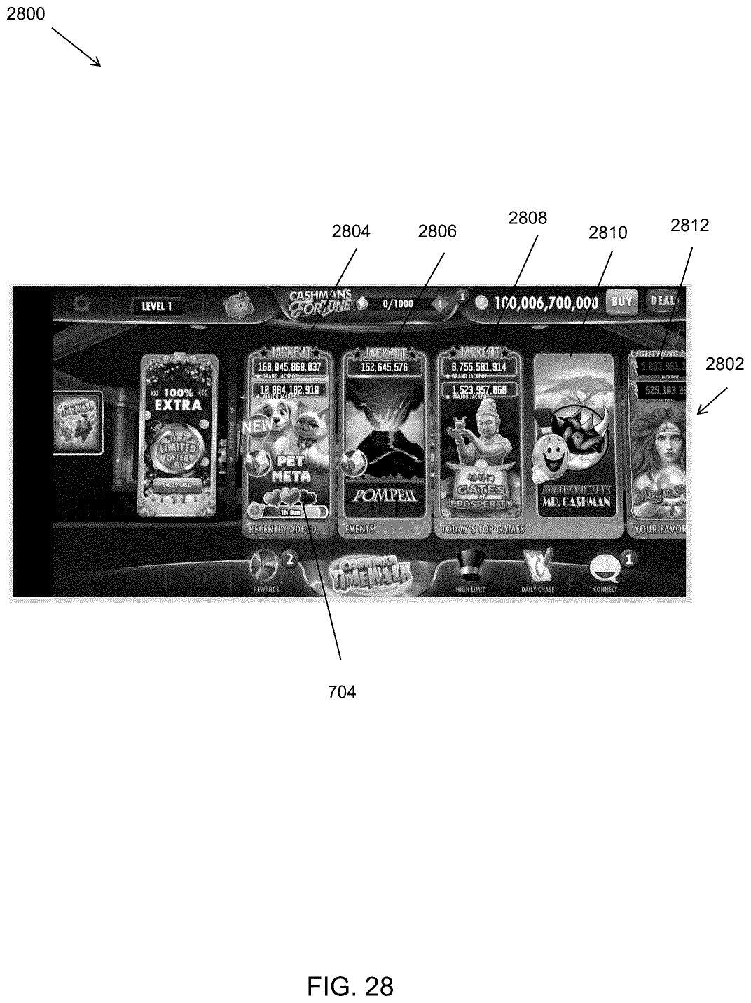

In some embodiments, a reminder/count down in a game lobby (e.g., on a game tile corresponding to the example game described herein) may be displayed to communicate how much time is left to visit pet 504 before a heart is removed (e.g., see FIG. 28). Thus, even when the electronic game described herein is not being played, a status of heart meter 704 is being tracked and a player can easily view the status of heart meter 704 in the game lobby. In some embodiments, push notifications may be sent to a player device associated with the player account (e.g., reminders to visit pet 504, notifications regarding changes in status of heart meter 704, etc.).

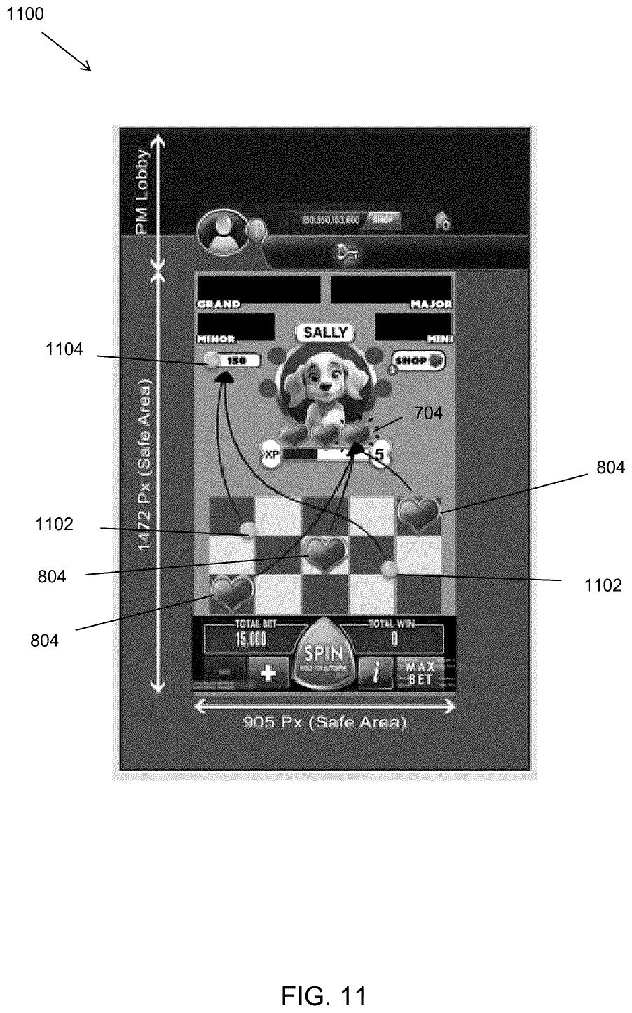

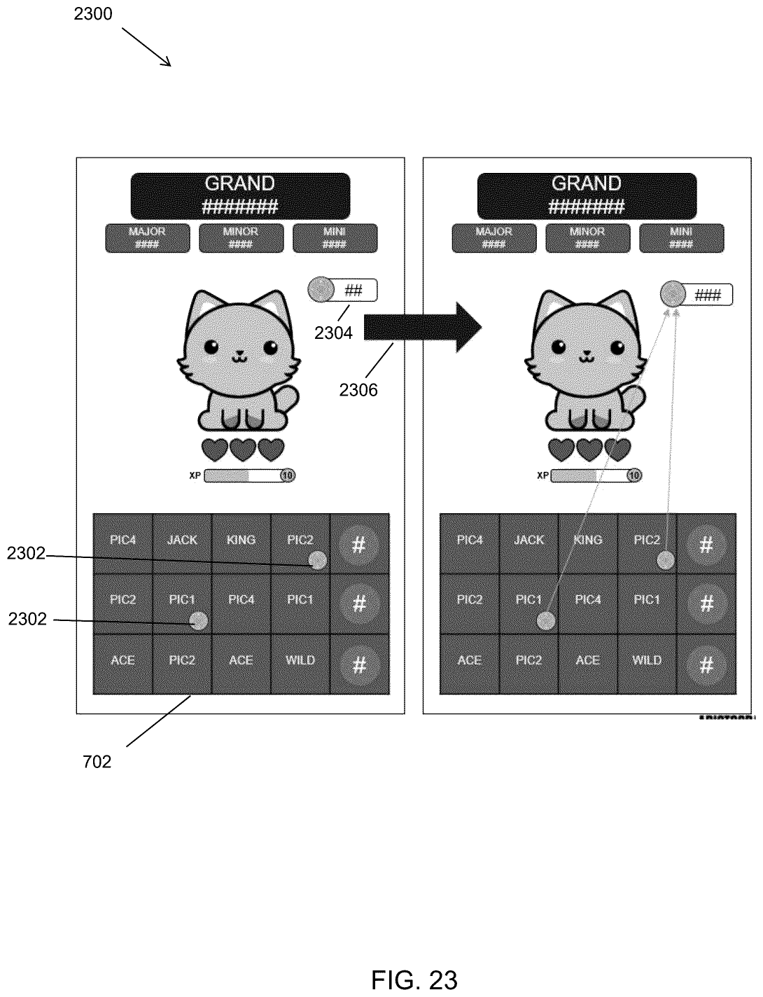

FIG. 11 illustrates another example screenshot and/or interface 1100 of the electronic game shown in FIGS. 9 and 10. As shown in FIG. 11, heart meter 704 is filling (e.g., based on heart symbols 804 landing on reels 702). Further, secondary currency 1102 (e.g., coins, collectibles, etc.) are being added to a player wallet 1104, as explained in further detail herein (e.g., see FIG. 23).

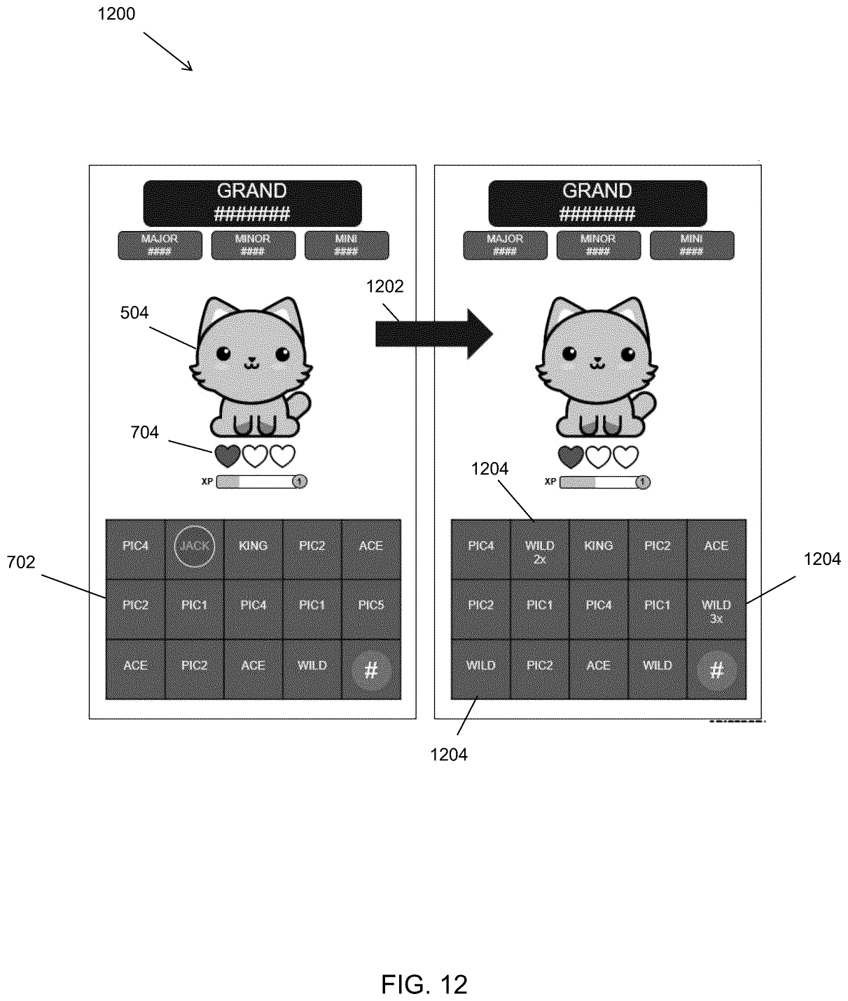

FIG. 12 illustrates another example screenshot and/or interface 1200 of an electronic game and/or transition thereof including a persistent feature while gameplay is active and inactive, in accordance with the present disclosure. Randomly, on any spin (e.g., because a first position of heart meter 704 is filled), Wilds may be added to reels 702. For instance, pet 504 may be displayed as adding Wilds to reels 702. Wilds may be regular Wilds or Multiplier Wilds ranging from 2×-5×. In some embodiments, between three and five Wilds may be added.

As shown in FIG. 12, an outcome is provided on reels 702 and then a transition 1202 occurs where Wilds 1204 (including Multiplier Wilds) are added to reels 702 (e.g., by pet 504).

For a cat pet, Wilds may be added by displaying a laser pointer that randomly lands on a symbol position on reels 702 where a Wild will be placed. The cat may be displayed as pouncing on the symbol position, and the Wild is revealed.

For a dog pet, Wilds may be added by the dog randomly picking a symbol position on reels 702 and being displayed as digging. Once the dog digging animation has finished, the Wild is revealed.

In the example embodiment, heart symbols are evaluated prior to Wilds being randomly placed on reels 702. Once evaluated, symbol positions where heart symbols are displayed are eligible for Wild placements. In the example embodiment, the randomly-placed Wilds may never overwrite existing Wilds or COR symbols on reels 702.

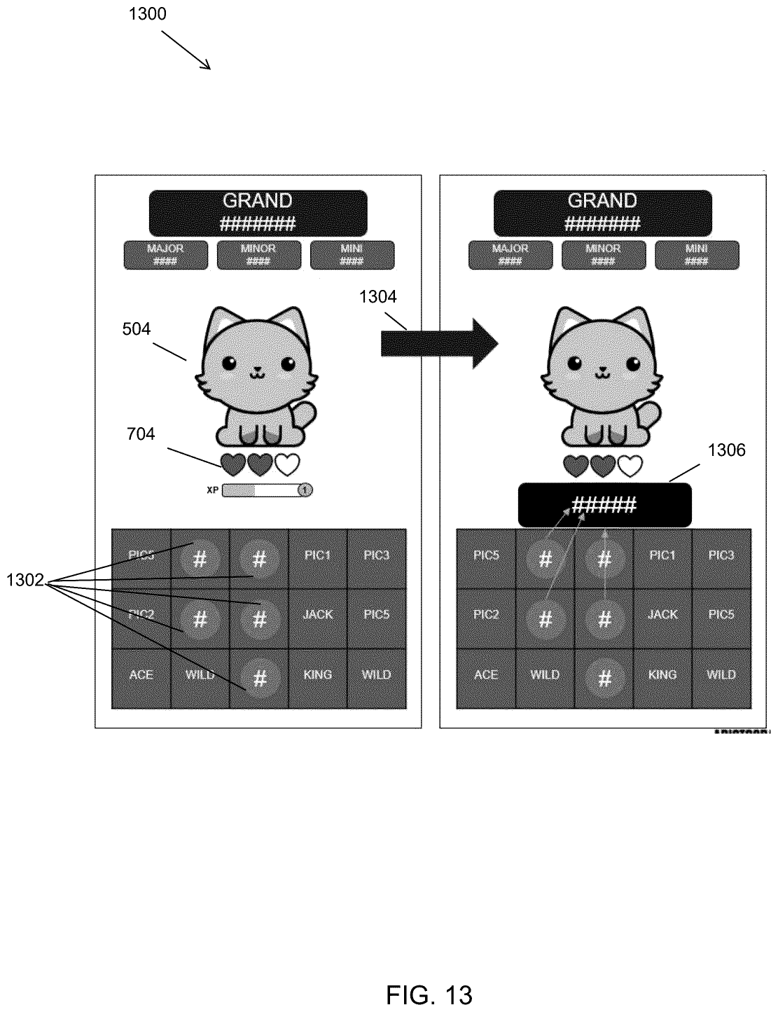

FIG. 13 illustrates another example screenshot and/or interface 1300 of an electronic game and/or transition thereof including a persistent feature while gameplay is active and inactive, in accordance with the present disclosure. In the example shown in FIG. 13, blast CORs are randomly provided on any spin with COR symbols available (e.g., because of a second position of heart meter 704 being filled), and pet 504 may be displayed as blasting values associated with any number of COR symbols on reels 702 and instantly causing them to be awarded. For instance, as shown in FIG. 13, COR symbols 1302 are provided during a play of the electronic game. A transition 1304 occurs and values associated with COR symbols 1302 are instantly provided. A sum 1306 of the values associated with COR symbols 1302 may be displayed.

For a cat pet, COR symbols may be displayed as balls of yarn. The cat may be displayed as randomly batting at and/or unravelling the balls of yarn COR symbols to award them to the player account.

For a dog pet, COR symbols may be displayed as balls. The dog may be displayed as randomly fetching the ball COR symbols and awarding them to the player account.

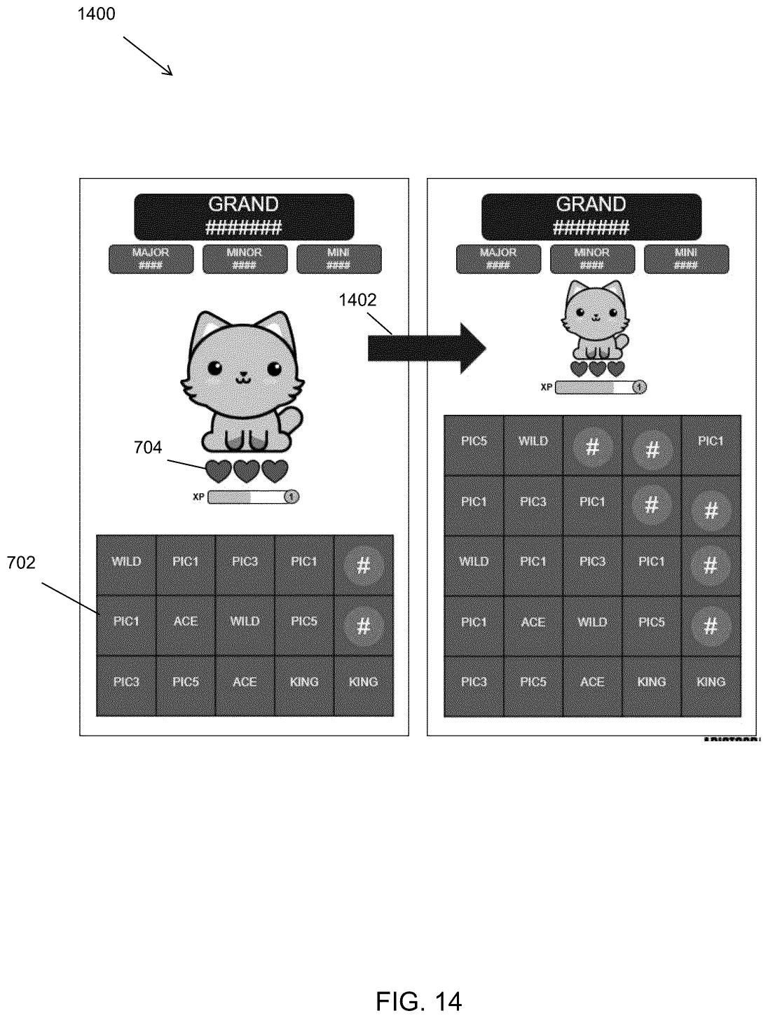

FIG. 14 illustrates another example screenshot and/or interface 1400 of an electronic game and/or transition thereof including a persistent feature while gameplay is active and inactive, in accordance with the present disclosure. In the example shown in FIG. 14, reels 702 may randomly grow one to three additional rows high (e.g., because of a third position of heart meter 704 being filled). For instance, in FIG. 14, a game outcome is provided on reels 702 and it is randomly determined that additional rows (e.g., two) will be added. Accordingly, a transition 1402 occurs and two additional rows are added to reels 702.

In some embodiments, pet 504 may be displayed as causing the additional row(s) to be added. Additional rows yield more possible line wins in the electronic game (e.g., 4×5, 40 Lines; 5×5, 50 Lines; 6×5, 60 Lines). Further, more symbol positions are provided for COR symbols to be provided and possibly trigger the hold and spin game, as explained herein.

For a cat pet, additional rows may be presented by the cat playing with a feather/wand toy. As the cat reaches up to bat at the feathers, reels 702 are displayed as growing.

For a dog pet, additional rows may be presented as the dog tugging on reels 702 like a rope toy. As the dog tugs harder and harder, reels 702 are displayed as growing.

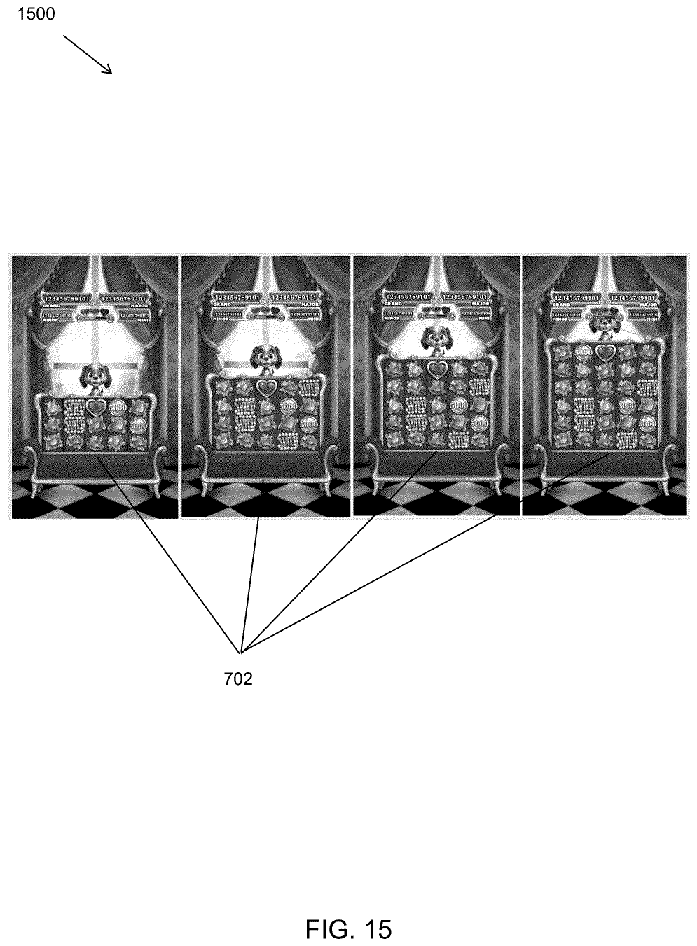

FIG. 15 illustrates another example screenshot and/or interface 1500 of the electronic game shown in FIG. 14 where reels 702 with different numbers of rows are displayed.

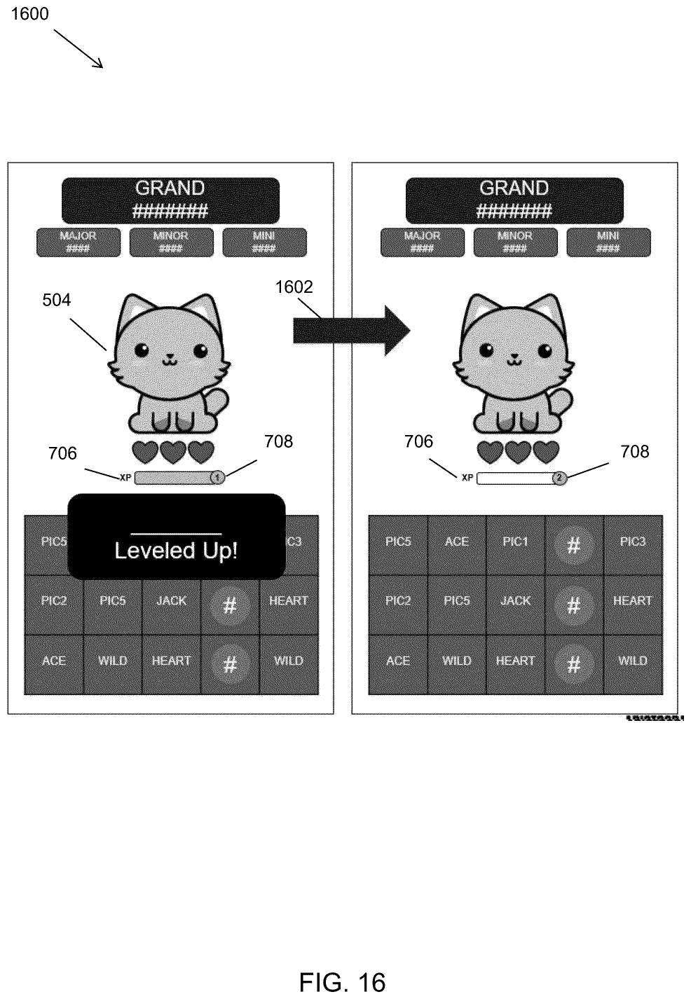

FIG. 16 illustrates another example screenshot and/or interface 1600 of an electronic game and/or transition thereof including a persistent feature while gameplay is active and inactive, in accordance with the present disclosure. In the example embodiment, when pet 504 performs one of its corresponding features (e.g., provides a game enhancement associated with heart meter 704), XP meter 706 increases. When the XP meter 706 is completely filled, pet 504 increases in level. For instance, as shown in FIG. 16, XP meter 706 is filled (e.g., with badge 708 showing level one), followed by a transition 1602 resulting in XP meter 706 being empty and badge 708 being updated to correspond to the new level (e.g., level two) of pet 504.

At a predetermined level, a pet shop may be unlocked wherein secondary currency (e.g., collectibles) can be spent (e.g., to purchase free games/spins, game enhancements, cosmetic enhancements associated with pet 504, etc.). Additionally, certain previously-locked items (e.g., unavailable for purchase) may be unlocked (e.g., made available for purchase) as the pet's level increases. The pet's level can also be displayed on an avatar badge (e.g., associated with the player account) to show the pet's progress.

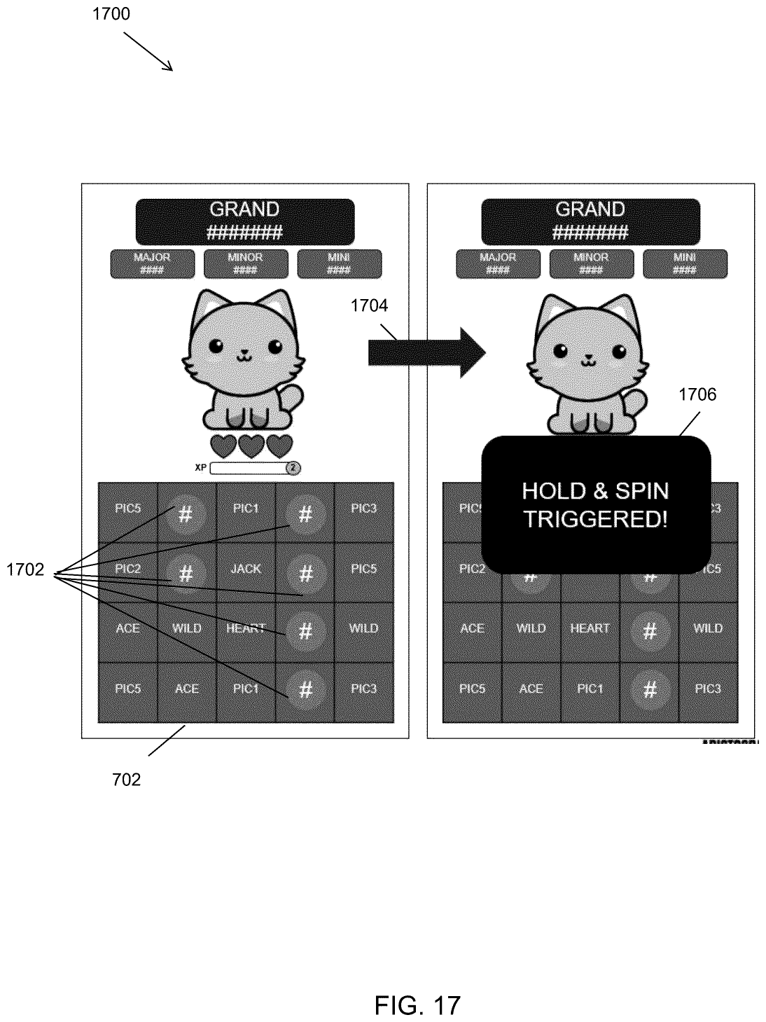

FIG. 17 illustrates another example screenshot and/or interface 1700 of an electronic game and/or transition thereof including a persistent feature while gameplay is active and inactive, in accordance with the present disclosure. In the example embodiment, whenever six or more COR symbols land on reels 702 during a play of the base game and/or are revealed when reels 702 are randomly grown (e.g., randomly-determined symbols are provided at the new rows when reels 702 expand), a hold and spin game may be triggered (e.g., where COR symbols are held in place from spin to spin, and any symbol positions not already including a COR symbol are respun for each spin). At the end of the hold and spin game (e.g., when no spins remain), values associated with each COR symbol on reels are summed and provided.

For instance, in FIG. 17, six COR symbols 1702 are provided on reels 702. Accordingly, a transition 1704 to the hold and spin game is provided (e.g., as indicated by message 1706).

In the example embodiment, the size of the matrix for the hold and spin game starts at the same size as the matrix during the spin of the base game where the hold and spin game was triggered (e.g., if reels 702 are grown to a 4×5 matrix and six or more COR symbols are revealed, the hold and spin game starts on a 4×5 matrix).

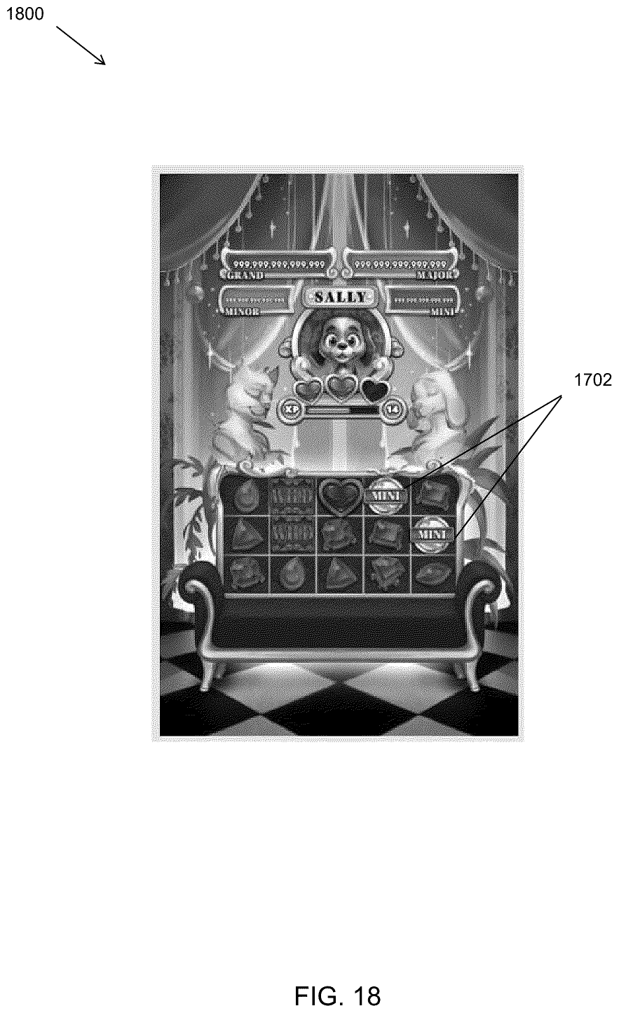

FIG. 18 illustrates another example screenshot and/or interface 1800 of the electronic game shown in FIG. 17 with example COR symbols 1702 displayed thereon.

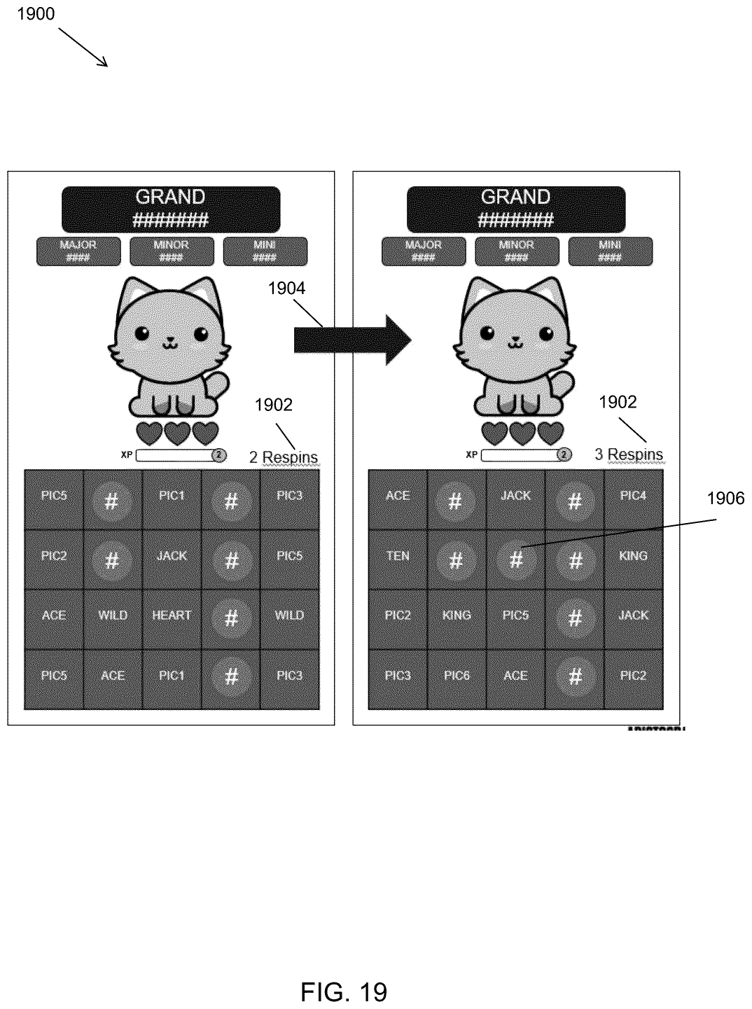

FIG. 19 illustrates another example screenshot and/or interface 1900 of an electronic game and/or transition thereof including a persistent feature while gameplay is active and inactive, in accordance with the present disclosure. In the example embodiment, three free spins are provided at the start of the hold and spin game. Whenever a new COR symbol is provided, the free spin count may be reset (e.g., to three).

For instance, in the example shown in FIG. 19, two respins show on a spin counter 1902 for the hold and spin game. During a next play of the hold and spin game, as indicated by transition 1904, a new COR symbol 1906 is provided and, accordingly, spin counter 1902 is reset to three spins.

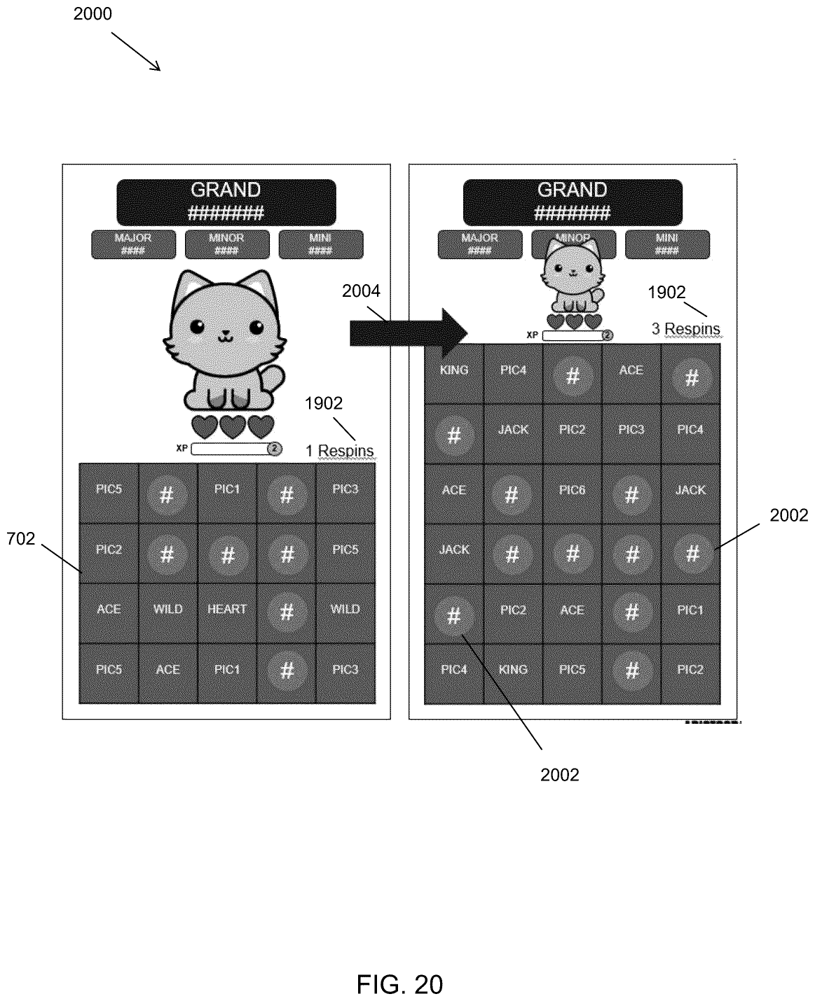

FIG. 20 illustrates another example screenshot and/or interface 2000 of an electronic game and/or transition thereof including a persistent feature while gameplay is active and inactive, in accordance with the present disclosure. In the example embodiment of the hold and spin game, on any respin, the pet may perform any of its COR related random features if they have been unlocked (e.g., adding Wilds to reels 702, growing reels 702 by one to three rows, “blasting” a random number of COR symbols). Animations during the hold and spin game may function the same as animations in the base game.

For instance, as shown in FIG. 20, one respin remains on spin counter 1902. New CORs 2002 are provided during the one remaining respin. Thus, after transition 2004 (e.g., illustrating that the one remaining respin occurred), spin counter 1902 is reset to three respins. Before the one remaining respin, it was also randomly determined to expand reels 702. Thus, reels 702 are expanded (e.g., here, by two rows) before the one remaining respin.

In some embodiments, if it is determined that reels 702 should grow (e.g., expand), reels 702 will grow prior to a next play of the hold and spin game to ensure that if no new COR symbols land and no respins remain, the newly added row(s) will be utilized for at least one play (e.g., as shown in FIG. 20).

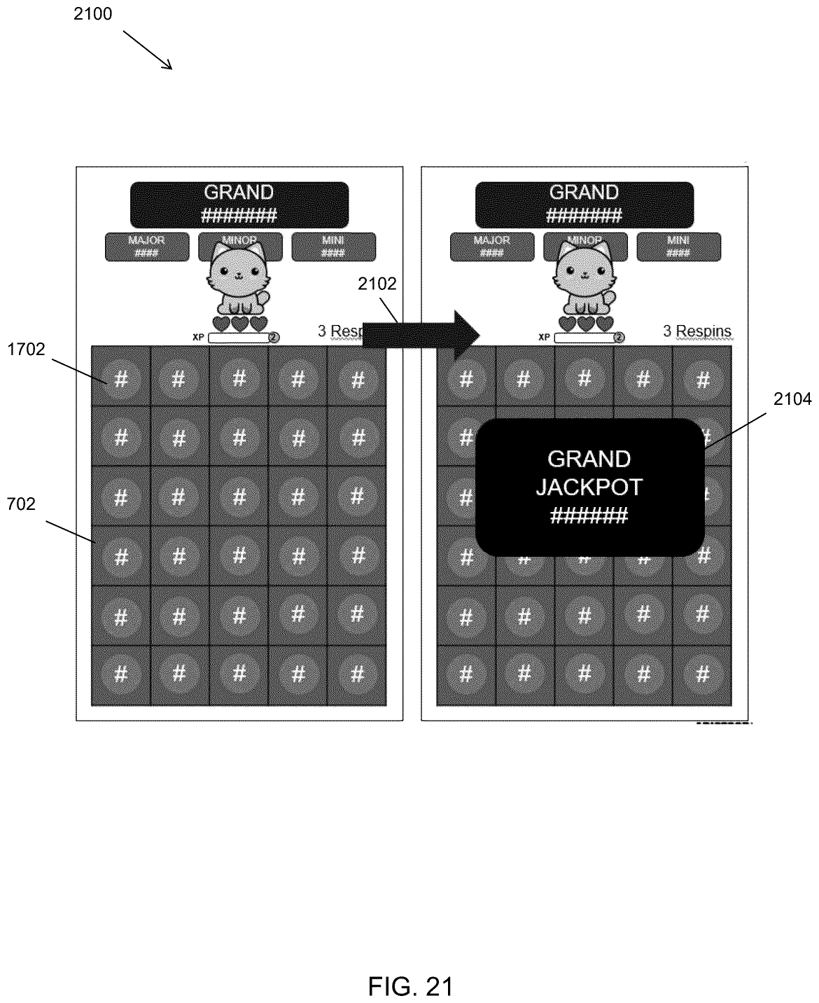

FIG. 21 illustrates another example screenshot and/or interface 2100 of an electronic game and/or transition thereof including a persistent feature while gameplay is active and inactive, in accordance with the present disclosure. In the example embodiment, if the reel matrix is grown to a 6×5 matrix and each symbol position on reels 702 is filled with COR symbols 1702, a grand jackpot is awarded. For instance, in FIG. 21 each symbol position on reels 702 (e.g., in a 6×5 matrix) includes a COR symbol displayed thereon. Thus, transition 2102 occurs and the grand jackpot is provided (e.g., as indicated by message 2104). When the hold and spin game ends (e.g., no respins remain), the values associated with all displayed COR symbols 1702 may be summed and provided (e.g., in addition to the grand jackpot being provided).

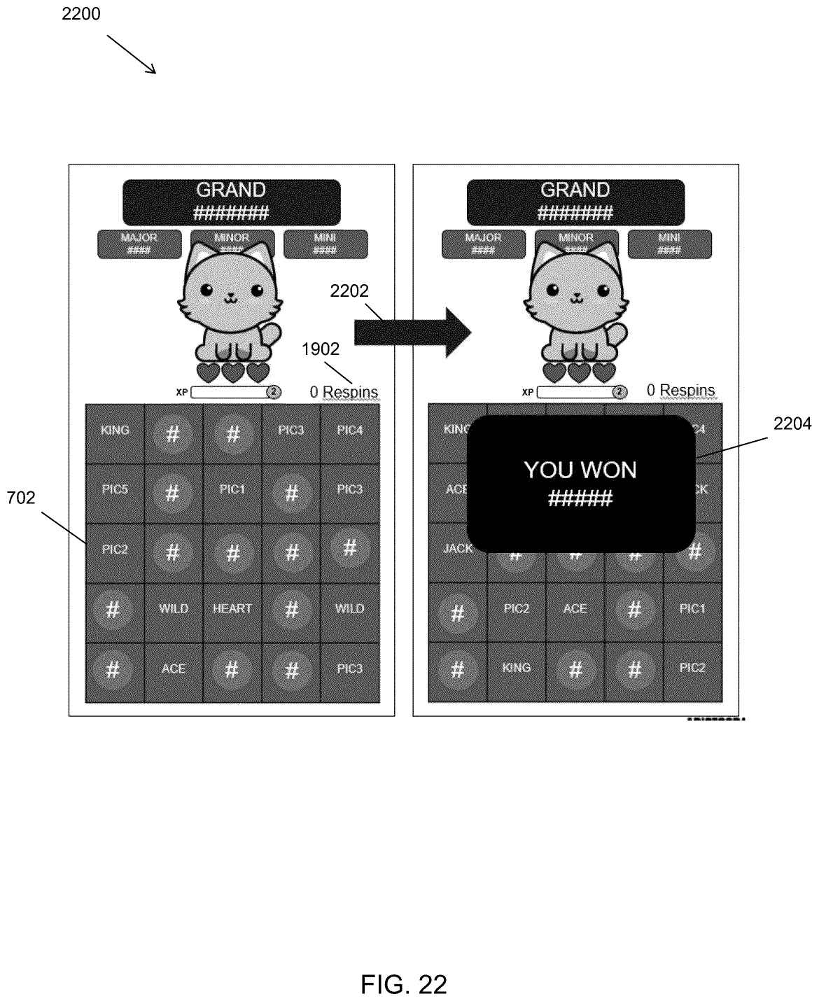

FIG. 22 illustrates another example screenshot and/or interface 2200 of an electronic game and/or transition thereof including a persistent feature while gameplay is active and inactive, in accordance with the present disclosure. For instance, FIG. 22 illustrates an example of the hold and spin game where the grand jackpot is not provided. In this example, the hold and spin game ends when no respins remain (e.g., as shown on spin counter 1902). Values associated with the COR symbols that have landed on reels 702 are summed and provided (e.g., as shown after transition 2202 in message 2204).

After the hold and spin game, gameplay is transitioned back to the base game. In the example embodiment, if reels 702 were grown before and/or during the hold and spin game, the matrix is reset to 3×5 on the next paid spin (e.g., the first play of the base game after gameplay transitions from the hold and spin game to the base game).

FIG. 23 illustrates another example screenshot and/or interface 2300 of an electronic game and/or transition thereof including a persistent feature while gameplay is active and inactive, in accordance with the present disclosure. Once a pet has reached a predetermined level, a secondary currency feature and shop may be unlocked. Secondary currency may be awarded on any spin (e.g., of the base game). For instance, as shown in FIG. 23, secondary currency symbols 2302 are displayed (e.g., randomly) as an overlay on reels 702 and a player secondary currency wallet 2304 is provided. After transition 2306, secondary currency associated with secondary currently symbols 2302 is added to wallet 2304.

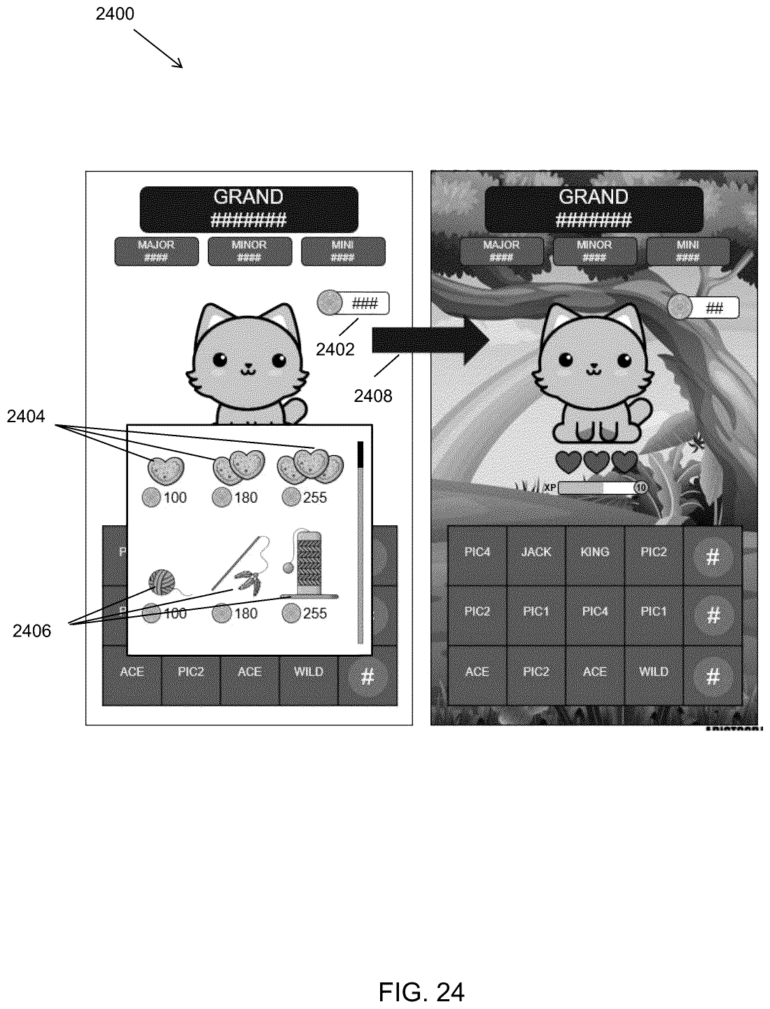

FIG. 24 illustrates another example screenshot and/or interface 2400 of an electronic game and/or transition thereof including a persistent feature while gameplay is active and inactive, in accordance with the present disclosure. When a secondary currency wallet icon 2402 is selected, the shop is displayed. In the example embodiment, the shop includes items such as: treats 2404 (e.g., awarding +1 to +3 hearts to help autofill the pet's happiness meter, an animation may be provided of the pet being fed the treat), toys 2406 (e.g., awarding +1 to +3 hearts to help autofill the pet's happiness meter, an animation may be provided where the pet plays with the toy), cosmetic enhancements (e.g., pet environments such as backgrounds that are available to be displayed during gameplay, pet outfits such as different portraits of the pet in various outfits that players can equip as their avatar), buy a bonus (e.g., a 3×5, 4×5, 5×5, and/or 6×5 hold and spin game may be purchased), and/or a pet hotel (e.g., the pet may be placed in a hotel while the player is away (e.g., not playing the game) so that heart meter progress does not deteriorate). In some embodiments, primary currency may be provided for completing cosmetic sets.

In the example of FIG. 24, once the shop is closed (e.g., and/or a purchase in the shop is made), a transition 2408 occurs and the electronic game is again displayed.

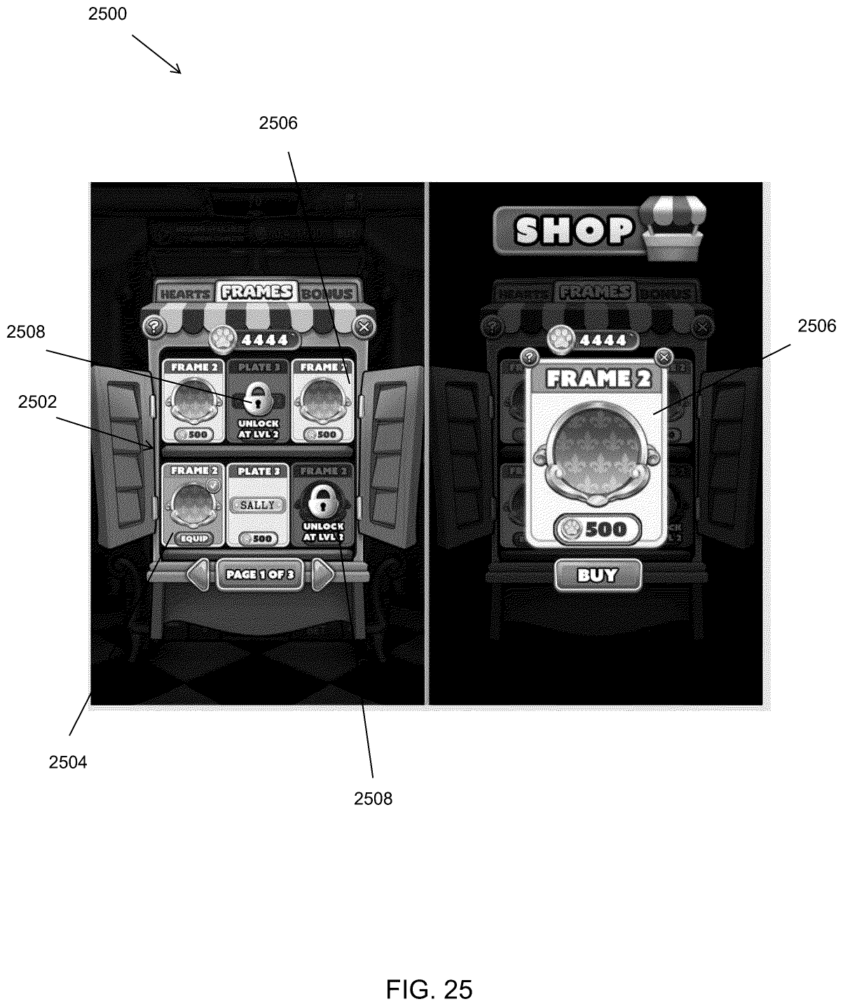

FIG. 25 illustrates another example screenshot and/or interface 2500 of the shop shown in FIG. 24. For instance, FIG. 25 shows cosmetic enhancements 2502 being available for purchase in the shop. Further, previously purchased items (e.g., frame 2504) are available for selection. As an example, when frame 2504 is selected, pet 504 will be displayed within frame 2504.

Further, when an item that is available for purchase is selected, the selected item may enlarge for better viewing and for the player to confirm the purchase. FIG. 25 illustrates an example where frame 2506 is selected for purchase and, after a transition, frame 2506 is expanded in the shop.

Additionally, items that are not available for purchase (e.g., that are locked based upon pet level), are displayed with a lock symbol 2508 overlaid thereon to communicate that the items are not available for purchase.

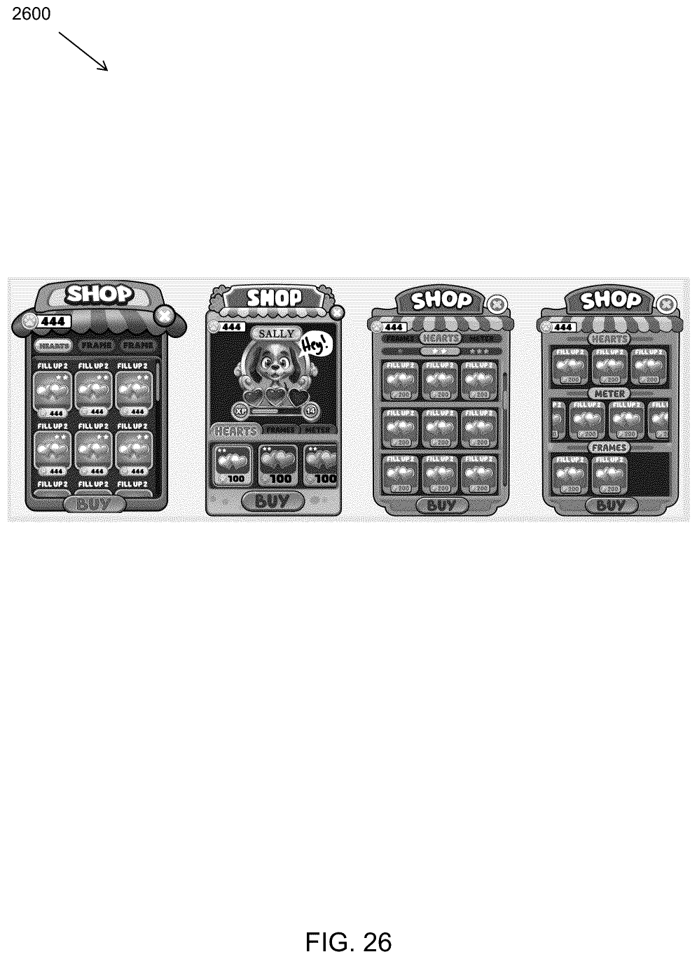

FIG. 26 illustrates additional example screenshots and/or interfaces 2600 of the shop shown in FIG. 24 and/or FIG. 25.

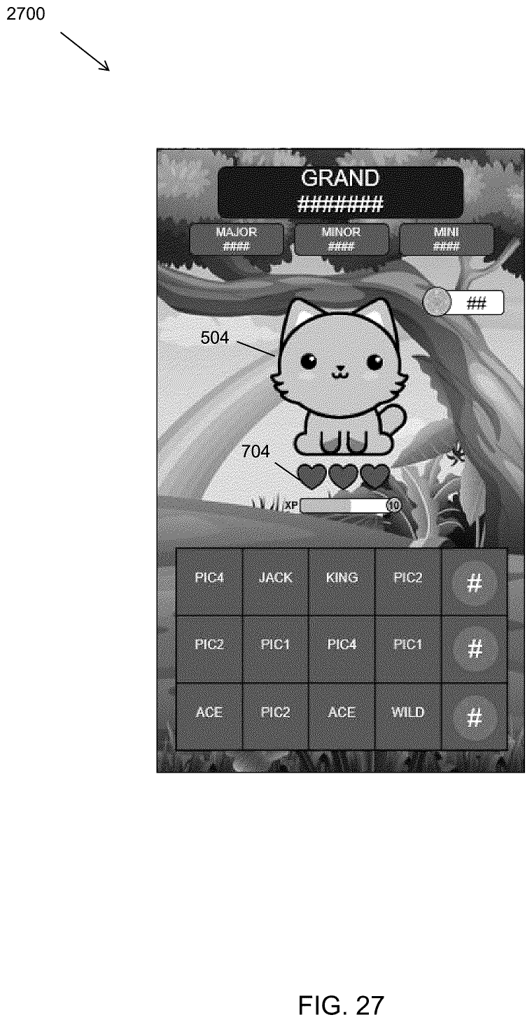

FIG. 27 illustrates another example screenshot and/or interface 2700 of an electronic game including a persistent feature while gameplay is active and inactive, in accordance with the present disclosure. As explained herein, the heart meter 704 encourages players to log in daily and visit their pet 504 (e.g., supporting player retention).

In some embodiments, packages of secondary currency may be sold. In some embodiments, a certain percentage of proceeds may be provided to animal shelters.

In some embodiments, pet types other than dog and/or cat may be available for adoption (e.g., panda, penguin, unicorn). In some embodiments, limited edition (e.g., for a limited amount of time) outfits, environments, and/or cosmetics may be provided (e.g., that are themed with holidays and/or other special events) in the shop.

In some embodiments, pets may be equipped with an outfit selected (e.g., and/or purchased) by a player. Players may be able to view their own and/or other players' “backyards” where all the items, outfits, and/or decorations they have purchased are displayed.

In some embodiments, players may be able to invite other players' pets to their slot game where the pets interact with gameplay together.

In some embodiments, secondary currency may be purchased, spent, and/or earned in electronic games different from the electronic games described herein.

FIG. 28 illustrates another example screenshot and/or interface 2800 of an electronic game including a persistent feature while gameplay is active and inactive, in accordance with the present disclosure. As shown in FIG. 28, a game lobby 2802 is provided. Each tile 2804-2812 in lobby 2802 is associated with a different electronic game. As shown with respect to the pet game described herein, the status of pet 504 associated with the pet game is displayed in lobby 2802 for convenience (e.g., on tile 2804). In other words, the player doesn't have to be playing the pet game in order to view the status of pet 504 (e.g., heart meter 704, timer showing an amount of time at which a heart will be lost if the game is not played).

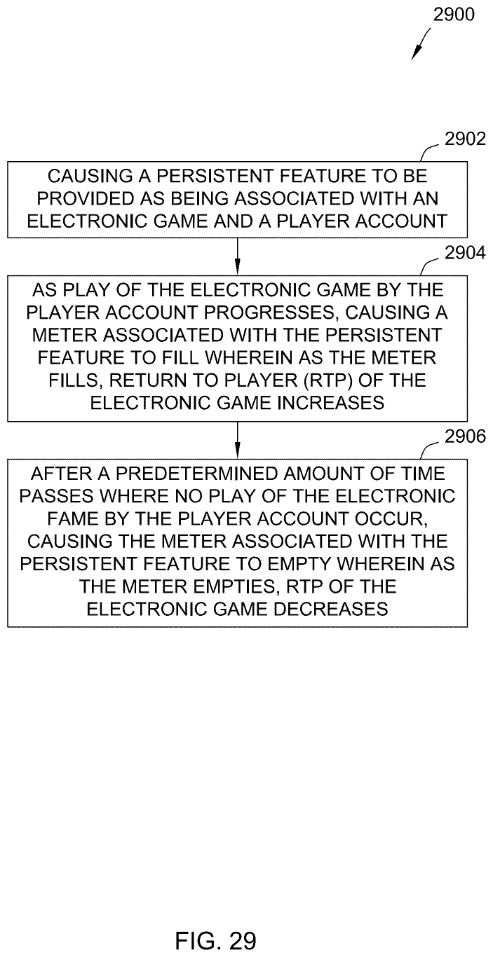

FIG. 29 illustrates an example method 2900 of electronic gaming including a persistent feature while gameplay is active and inactive, in accordance with the present disclosure.

In the example embodiment, method 2900 includes causing 2902 a persistent feature to be provided as being associated with an electronic game and a player account and, as play of the electronic game by the player account progresses, causing 2904 a meter associated with the persistent feature to fill wherein as the meter fills, return to player (RTP) of the electronic game increases, and wherein the meter is caused to be filled based at least in part upon at least one bonus symbol being provided during play of the electronic game. The example embodiment of method 2900 also includes, after a predetermined amount of time passes where no plays of the electronic game by the player account occur, causing 2906 the meter associated with the persistent feature to empty wherein as the meter empties, RTP of the electronic game decreases.

In some embodiments, method 2900 includes randomly causing collectibles to be provided during play of the electronic game.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. An electronic gaming system comprising:
at least one memory with instructions stored thereon; and
at least one processor in communication with the at least one memory, wherein the instructions, when executed by the at least one processor, cause the at least one processor to:
cause a persistent feature to be provided as being associated with an electronic game and a player account;
as play of the electronic game by the player account progresses, cause a meter associated with the persistent feature to fill, wherein as the meter fills, return to player (RTP) of the electronic game increases, and wherein the meter is caused to be filled based at least in part upon at least one bonus symbol being provided during play of the electronic game; and
after a predetermined amount of time passes where no plays of the electronic game by the player account occur, cause the meter associated with the persistent feature to empty, wherein as the meter empties, RTP of the electronic game decreases.

2. The electronic gaming system of claim 1, wherein the instructions further cause the at least one processor to randomly cause collectibles to be provided during play of the electronic game.

3. The electronic gaming system of claim 2, wherein the instructions further cause the at least one processor to randomly cause the collectibles to be provided as an overlay at one or more symbol positions of a plurality of symbol positions for the electronic game.

4. The electronic gaming system of claim 2, wherein the instructions further cause the at least one processor to cause the collectibles to be stored in the player account.

5. The electronic gaming system of claim 4, wherein the instructions further cause the at least one processor to cause the collectibles to be stored in the player account as being associated with input amounts at which the electronic game was being played at when the collectibles were provided.

6. The electronic gaming system of claim 5, wherein the instructions further cause the at least one processor to cause a cosmetic enhancement to be applied to the persistent feature based upon an input of an amount of collectibles from the player account.

7. The electronic gaming system of claim 5, wherein the instructions further cause the at least one processor to cause a bonus play of the electronic game to be provided based upon receipt an input of an amount of collectibles from the player account.

8. The electronic gaming system of claim 7, wherein the instructions further cause the at least one processor to determine an RTP for the bonus play based at least in part upon one or more input amounts of the input amounts at which the electronic game was being played at when the collectibles were provided.

9. The electronic gaming system of claim 1, wherein the instructions further cause the at least one processor to, in a virtual game lobby comprising a plurality of selectors associated with a plurality of electronic games, cause a status of the meter to be displayed on the selector of the plurality of selectors associated with the electronic game.

10. At least one non-transitory computer-readable storage medium with instructions stored thereon that, in response to execution by at least one processor, cause the at least one processor to:
cause a persistent feature to be provided as being associated with an electronic game and a player account;
as play of the electronic game by the player account progresses, cause a meter associated with the persistent feature to fill, wherein as the meter fills, return to player (RTP) of the electronic game increases, and wherein the meter is caused to be filled based at least in part upon at least one bonus symbol being provided during play of the electronic game; and
after a predetermined amount of time passes where no plays of the electronic game by the player account occur, cause the meter associated with the persistent feature to empty, wherein as the meter empties, RTP of the electronic game decreases.

11. The at least one non-transitory computer-readable storage medium of claim 10, wherein the instructions further cause the at least one processor to randomly cause collectibles to be provided during play of the electronic game.

12. The at least one non-transitory computer-readable storage medium of claim 11, wherein the instructions further cause the at least one processor to randomly cause the collectibles to be provided as an overlay at one or more symbol positions of a plurality of symbol positions for the electronic game.

13. The at least one non-transitory computer-readable storage medium of claim 11, wherein the instructions further cause the at least one processor to cause the collectibles to be stored in the player account.

14. The at least one non-transitory computer-readable storage medium of claim 13, wherein the instructions further cause the at least one processor to cause the collectibles to be stored in the player account as being associated with input amounts at which the electronic game was being played at when the collectibles were provided.

15. The at least one non-transitory computer-readable storage medium of claim 14, wherein the instructions further cause the at least one processor to cause a cosmetic enhancement to be applied to the persistent feature based upon an input of an amount of collectibles from the player account.

16. The at least one non-transitory computer-readable storage medium of claim 14, wherein the instructions further cause the at least one processor to cause a bonus play of the electronic game to be provided based upon receipt an input of an amount of collectibles from the player account.

17. The at least one non-transitory computer-readable storage medium of claim 16, wherein the instructions further cause the at least one processor to determine an RTP for the bonus play based at least in part upon one or more input amounts of the input amounts at which the electronic game was being played at when the collectibles were provided.

18. The at least one non-transitory computer-readable storage medium of claim 10, wherein the instructions further cause the at least one processor to, in a virtual game lobby comprising a plurality of selectors associated with a plurality of electronic games, cause a status of the meter to be displayed on the selector of the plurality of selectors associated with the electronic game.

19. A method of electronic gaming implemented by at least one processor in communication with at least one memory, the method comprising:
causing a persistent feature to be provided as being associated with an electronic game and a player account;
as play of the electronic game by the player account progresses, causing a meter associated with the persistent feature to fill, wherein as the meter fills, return to player (RTP) of the electronic game increases, and wherein the meter is caused to be filled based at least in part upon at least one bonus symbol being provided during play of the electronic game; and
after a predetermined amount of time passes where no plays of the electronic game by the player account occur, causing the meter associated with the persistent feature to empty, wherein as the meter empties, RTP of the electronic game decreases.

20. The method of claim 19, further comprising randomly causing collectibles to be provided during play of the electronic game.
